(19) United States
(12) Patent Application Publication
(10) Pub. No.: US 2016/0267886 A1
(43) Pub. Date: Sep. 15, 2016

(54) METHOD OF CONTROLLING SCREEN AND ELECTRONIC DEVICE FOR PROCESSING METHOD

(71) Applicant: Samsung Electronics Co., Ltd., Gyeonggi-do (KR)

(72) Inventors: Doo-Suk KANG, Gyeonggi-do (KR); Jae-Bong CHUN, Gyeonggi-do (KR); Jaeseok JOO, Gyeonggi-do (KR); lnji JIN, Gyeonggi-do (KR)

(73) Assignee: Samsung Electronics Co., Ltd.

(21) Appl. No.: 15/067,971

(22) Filed: Mar. 11, 2016

(30) Foreign Application Priority Data
Mar. 11, 2015 (KR) 10-2015-0033899

(51) Int. Cl. G09G 5/377

(52) U.S. Cl. CPC G09G 5/377; G09G 2354/00; G09G 2358/00; G09G 2340/12

(57) ABSTRACT

A method of controlling a screen and an electronic device for processing the method are presented. The electronic device includes a display unit for displaying at least two execution screens and a controller for identifying an execution screen associated with security among execution screens displayed in accordance with activation of a security function and stopping displaying of at least some of the execution screen associated with security.

### PRIORITY

This application claims priority under 35 U.S.C. §119(a) to Korean Patent Application Serial No. 10-2015-0033899, which was filed in the Korean Intellectual Property Office on Mar. 11, 2015, the entire content of which is incorporated herein by reference.

### BACKGROUND

1. Field of the Disclosure

The present disclosure generally relates to a method of controlling a screen, and more particularly, to an electronic device for processing the method.

2. Description of the Related Art

According to recent rapid developments, electronic devices, which may exchange information or data, are used in various fields. In general, an electronic device may include a display for displaying an execution operation of an application. For example, the electronic device may display a reproduction screen of digital content on the display. According to another example, the electronic device may display a web search screen using a browser on the display.

The execution operation of the application (for example, a browser screen, a content reproduction screen, a message writing screen, or a scheduling setting screen) may be displayed through an execution area (for example, a window, a frame, or a layer) occupying some of the display area.

Further, the electronic device may simultaneously display a plurality of execution screens. For example, the electronic device may split a display area and display an execution screen in accordance with each of the split areas or overlap at least some of the execution screen with another execution screen.

In general, an electronic device may stop displaying a screen to prevent an unintended input and reduce battery consumption due to an unnecessary screen display, and provide security when a predetermined time passes.

However, the electronic device is able to stop displaying in an entire display but not able to stop displaying only in some areas of the display. Accordingly, it is difficult to prevent at least some pieces of information, which are displayed while the user controls the electronic device, from being exposed.

### SUMMARY

Various aspects of the present disclosure provide a method of controlling a screen and an electronic device for processing the method, which may prevent at least some pieces of information, which are displayed while the user controls the electronic device, from being displayed.

In accordance with an aspect of the present disclosure, a method of controlling a screen by an electronic device is provided. The method includes displaying at least two execution screens, identifying an execution screen associated with security among execution screens displayed in accordance with activation of a security function, and stopping the displaying of at least some of the execution screen associated with security.

In accordance with another aspect of the present disclosure, an electronic device for controlling a screen is provided. The electronic device includes a display unit for displaying at least two execution screens, and a controller for identifying an execution screen associated with security among execution screens displayed in accordance with activation of a security function and stopping the displaying of at least some of the execution screen associated with security.

In accordance with an aspect of the present disclosure, a computer-readable recording medium having a program recorded therein to execute a process is provided. The process includes displaying at least two execution screens, identifying an execution screen associated with security among execution screens displayed in accordance with activation of a security function, and stopping the displaying of at least some of the execution screen associated with security.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates an electronic device within a network environment according to various embodiments of the present disclosure;

FIG. 2 is a block diagram of an electronic device according to various embodiments of the present disclosure;

FIG. 3 is a block diagram of a program module according to various embodiments of the present disclosure;

FIG. 4 is a block diagram illustrating an electronic device according to various embodiments of the present disclosure;

FIG. 5 is a flowchart illustrating a screen control process of an electronic device according to various embodiments of the present disclosure;

FIGS. 6A and 6B illustrate examples for describing a process in which an electronic device displays an alternative screen in a security area according to various embodiments of the present disclosure;

FIG. 7 illustrates an example for describing another process in which the electronic device displays the alternative screen in the security area according to various embodiments of the present disclosure;

FIG. 8 is a flowchart illustrating a process of an operation in which an electronic device sets a security area according to various embodiments of the present disclosure;

FIGS. 9A and 9B illustrate examples for describing a process of an electronic device for defining a security area based on an input for setting a display area according to various embodiments of the present disclosure;

FIG. 10 is a flowchart illustrating a screen control process of an electronic device according to various embodiments of the present disclosure;

FIG. 11 is a flowchart illustrating a process of an operation for setting a security application in an electronic device according to various embodiments of the present disclosure;

FIGS. 12A and 12B illustrate examples for describing a process of an electronic device for defining a security application based on an input related to a selection of the application according to various embodiments of the present disclosure;

FIG. 13 illustrates an example for describing a process of an electronic device for defining a security application based on attributes of the application according to various embodiments of the present disclosure;

FIG. 14 is a flowchart illustrating a screen control process of an electronic device according to various embodiments of the present disclosure;

FIG. 15 is a flowchart illustrating a process of an electronic device for stopping displaying an execution screen of a security application according to various embodiments of the present disclosure;

FIG. 16 is a flowchart illustrating another process of the electronic device for stopping displaying the execution screen of the security application according to various embodiments of the present disclosure;

FIGS. 17A to 17C illustrate examples for describing a process in which the electronic device stops displaying the execution screen of the security application according to various embodiments of the present disclosure; and

FIGS. 18 to 25 illustrate situations in which the electronic device stops displaying the security area and/or the execution screen of the security application according to various embodiments of the present disclosure.

### DETAILED DESCRIPTION

Hereinafter, various embodiments of the present disclosure will be described in detail with reference to the accompanying drawings. In the following description, specific details such as detailed configuration and components are merely provided to assist the overall understanding of the embodiments of the present disclosure. Therefore, it should be apparent to those skilled in the art that various changes and modifications of the embodiments described herein may be made without departing from the scope and spirit of the present disclosure. In addition, descriptions of well-known functions and constructions are omitted for clarity and conciseness.

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications/changes, equivalents, and/or alternatives falling within the spirit and scope of the present disclosure. In describing the drawings, similar reference numerals may be used to designate similar elements.

The terms “have”, “may have”, “include”, or “may include” used in the various embodiments of the present disclosure indicate the presence of disclosed corresponding functions, operations, elements, and the like, and do not limit additional one or more functions, operations, elements, and the like. In addition, it should be understood that the terms “include” or “have” used in the various embodiments of the present disclosure indicate the presence of features, numbers, steps, operations, elements, parts, or a combination thereof described in the specifications, and do not preclude the presence or addition of one or more other features, numbers, steps, operations, elements, parts, or a combination thereof.

The terms “A or B”, “at least one of A or/and B” or “one or more of A or/and B” used in the various embodiments of the present disclosure include any and all combinations of words enumerated with it. For example, “A or B”, “at least one of A and B” or “at least one of A or B” means (1) including at least one A, (2) including at least one B, or (3) including both at least one A and at least one B.

Although terms such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be referred to as a second element without departing from the scope of various embodiments of the present disclosure, and similarly, a second element may be referred to as a first element.

It will be understood that when an element (e.g., first element) is “connected to” or “(operatively or communicatively) coupled with/to” another element (e.g., second element), the element may be directly connected or coupled to another element, and there may be an intervening element (e.g., third element) between the element and another element. To the contrary, it will be understood that when an element (e.g., first element) is “directly connected” or “directly coupled” to another element (e.g., second element), there is no intervening element (e.g., third element) between the element and another element.

The expression “configured to (or set to)” used in various embodiments of the present disclosure may be replaced with “suitable for”, “having the capacity to”, “designed to”, “adapted to”, “made to”, or “capable of” according to the situation. The term “configured to (set to)” does not necessarily mean “specifically designed to” at a hardware level. Instead, the expression “apparatus configured to . . . ” may mean that the apparatus is “capable of . . . ” along with other devices or parts in a certain situation. For example, “a processor configured to (set to) perform A, B, and C” may be a dedicated processor, e.g., an embedded processor, for performing a corresponding operation, or a general-purpose processor, e.g., a Central Processing Unit (CPU) or an application processor (AP), capable of performing a corresponding operation by executing one or more software programs stored in a memory device.

The terms and expressions as used herein are used merely to describe certain embodiments and do not limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in various embodiments of the present disclosure.

An electronic device according to various embodiments of the present disclosure may include at least one of a smart phone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera, or a wearable device (e.g., a head-mount-device (HMD), electronic eye-glasses, electronic clothing, an electronic bracelet, an electronic necklace, an electronic appcessory, an electronic tattoo, a smart mirror, or a smart watch).

An electronic device according to various embodiments of the present disclosure may be a smart home appliance and may include a television (TV), a digital video disk (DVD) player, an audio component, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ PlayStation™), an electronic dictionary, an electronic key, a camcorder, or an electronic frame.

An electronic device according to various embodiments of the present disclosure may include a medical equipment (e.g., a mobile medical device (e.g., a blood glucose monitoring device, a heart rate monitor, a blood pressure monitoring device or a temperature meter), a magnetic resonance angiography (MRA) machine, a magnetic resonance imaging (MRI) machine, a computed tomography (CT) scanner, or an ultrasound machine), a navigation device, a global positioning system (GPS) receiver, an event data recorder (EDR), a flight data recorder (FDR), an in-vehicle infotainment device, an electronic equipment for a ship (e.g., ship navigation equipment and/or a gyrocompass), an avionics equipment, a security equipment, a head unit for vehicle, an industrial or home robot, an automatic teller machine (ATM), point of sale (POS) terminal, or an Internet of things (IoT) device (e.g., a lightbulb, various sensors, an electronic meter, a gas meter, a sprinkler, a fire alarm, a thermostat, a streetlamp, a toaster, a sporting equipment, a hot-water tank, a heater, a boiler and the like)

An electronic device according to various embodiments of the present disclosure may include at least one of a piece of furniture or a building/structure, an electronic board, an electronic signature receiving device, a projector, and various measuring instruments (e.g., a water meter, an electricity meter, a gas meter, or a wave meter).

An electronic device according to various embodiments of the present disclosure may also include a combination of one or more of the above-mentioned devices. Further, it will be apparent to those skilled in the art that an electronic device according to various embodiments of the present disclosure is not limited to the above-mentioned devices.

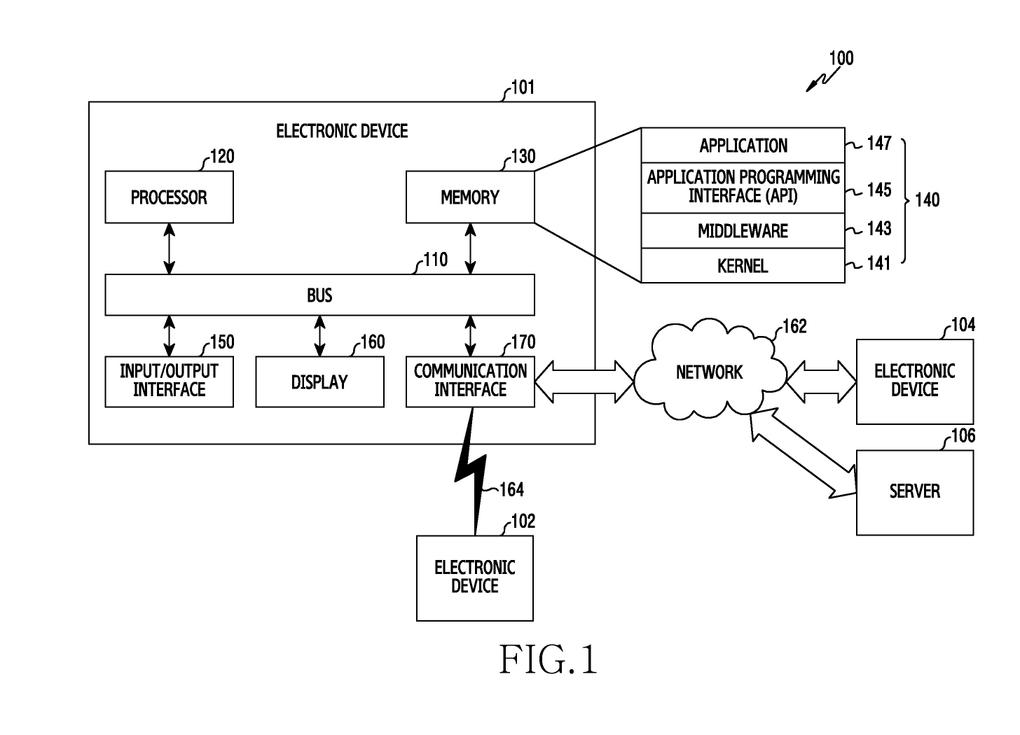

FIG. 1 is a view illustrating a network environment 100 including an electronic device 101 according to various embodiments of the present disclosure. Referring to FIG. 1, the electronic device 101 includes a bus 110, a processor 120, a memory 130, an input/output (I/O) interface 150, a display 160, and a communication interface 170.

The bus 110 may be a circuit for connecting the above-described elements with each other, and transferring communication (e.g., a control message) between the above-described elements.

The processor 120 may include a central processing unit (CPU), a communication processor (CP), a graphic processing unit (GPU).

The processor 120 may receive, for example, an instruction from the above-described other elements (e.g., the memory 130, the I/O interface 150, the display 160, or the communication interface 170, etc.) via the bus 110, interpret the received instruction, and execute an operation or a data process corresponding to the instruction.

The memory 130 may include volatile and/or non-volatile memory. The memory 130 may store an instruction or data received from the processor 120 or other elements (e.g., the I/O interface 150, the display 160, or the communication interface 170, etc.), or generated by the processor 120 or other elements. The memory 130 includes programming modules 140 such as a kernel 141, a middleware 143, an application programming interface (API) 145, or an application 147. Each of the programming modules may be configured using software, firmware, hardware, or a combination of two or more.

The kernel 141 may control or manage system resources (e.g., the bus 110, the processor 120, or the memory 130, etc.) used for executing an operation or a function implemented in the programming modules, for example, the middleware 143, the API 145, or the application 147. Also, the kernel 141 may provide an interface for allowing the middleware 143, the API 145, or the application 147 to access an individual element of the electronic device 101 and control or manage the same.

The middleware 143 may perform a role so that the API 145 or the application 147 may communicate with the kernel 141 to send and receive data. Also, in connection with task requests received from the application 147, the middleware 143 may perform a control (e.g., scheduling or load balancing) for a task request using, for example, a method of assigning priority that may use a system resource (e.g., the bus 110, the processor 120, or the memory 130, etc.) of the electronic device 101 to at least one application 147.

The API 145 is an interface for allowing the application 147 to control a function provided by the kernel 141 or the middleware 143, and may include at least one interface or function (e.g., an instruction) for file control, window control, image processing, or character control, etc.

The I/O interface 150 may transfer an instruction or data input from a user via an I/O unit (e.g., a sensor, a keyboard, or a touchscreen) to the processor 120, the memory 130, or the communication interface 170 via the bus 110. For example, the I/O interface 150 may provide data regarding a user's touch input via the touchscreen to the processor 120. Also, the I/O interface 150 may, for example, output an instruction or data received via the bus 110 from the processor 120, the memory 130, or the communication interface 170 via the I/O interface 150 (e.g., a speaker or a display). For example, the I/O interface 150 may output voice data processed by the processor 120 to a user via a speaker.

The display 160 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 160 may display various types of content (for example, text, images, videos, icons, or symbols) to users. The display 160 may include a touch screen, and may receive, for example, a touch, gesture, proximity, or hovering input by using an electronic pen or a part of the user's body.

The communication interface 170 may communicate between the electronic device 101 and an external device (for example, the electronic device 104 or the server 106). For example, the communication interface 170 may be connected to a network 162 through wireless communication or wired communication, and may communicate with an external device.

The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM) as a cellular communication protocol.

The wired communication may include, for example, at least one of universal serial bus (USB), high definition multimedia interface (HDMI), recommended standard 232 (RS-232), and plain old telephone service (POTS).

The network 162 may include at least one of communication networks such as a computer network (for example, a LAN or a WAN), the Internet, and a telephone network.

The electronic devices 102 and 104 may be devices of the same type as the electronic device 101 or different types from that of the electronic device 101. According to an embodiment of the present disclosure, the server 106 may include a group of one or more servers. All or some of the operations executed in the electronic device 101 may be carried out in another electronic device or a plurality of electronic devices (for example, the electronic devices 102, 104 or the server 106). When the electronic device 101 performs functions or services automatically or by request, the electronic device 101 may make a request for performing at least some functions related to the functions or services to another device 102, 104, or the server 106 instead of performing the functions or services by itself or additionally. The electronic device 102, 104, or the server 106 may carry out the functions requested by the electronic device 101 or additional functions and provide the results to the electronic device 101. The electronic device 101 may provide the requested functions or services to another electronic device based on the received results or after additionally processing the received results. To this end, cloud computing, distributed computing, or client-server computing technology may be used.

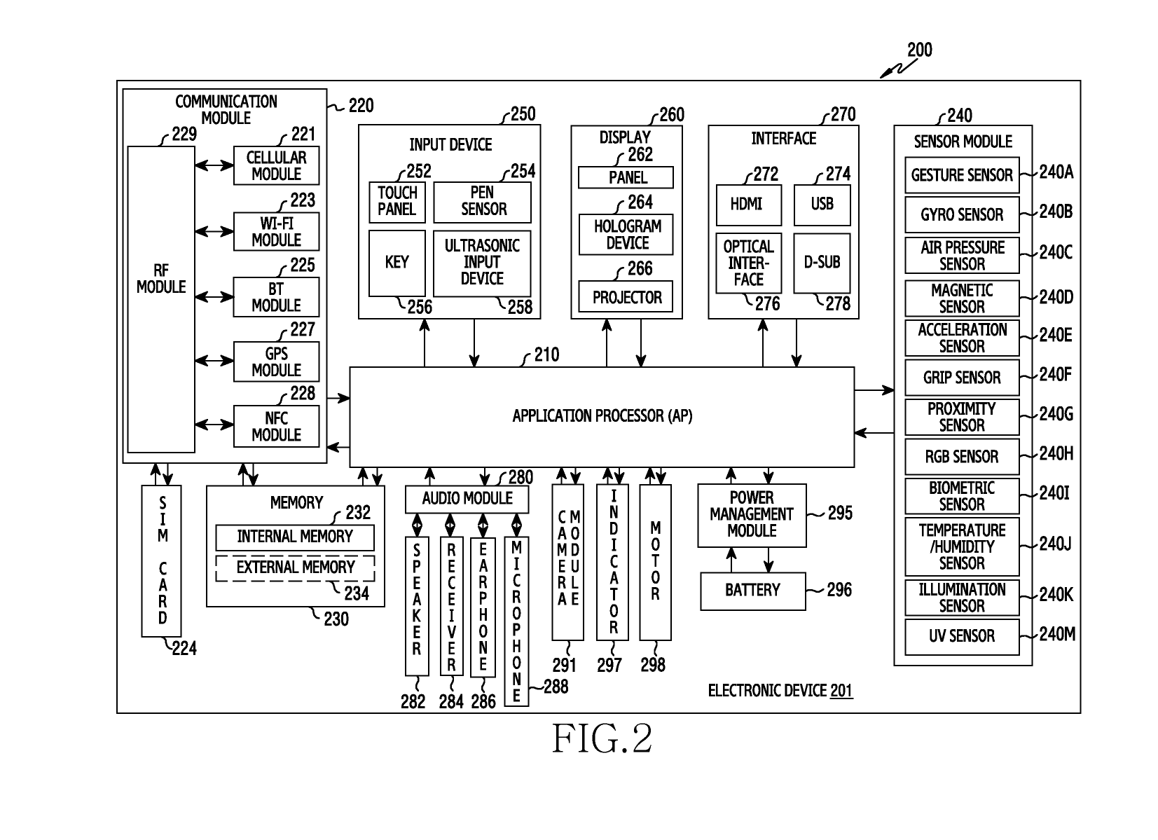

FIG. 2 is a block diagram 200 illustrating an electronic device 201 according to various embodiments of the present invention. The electronic device 201 may include, for example, all or a portion of the electronic device 101 illustrated in FIG. 1. Referring to FIG. 2, the electronic device 201 includes one or more application processors (AP) 210, a communication module 220, a subscriber identification module (SIM) card 224, a memory 230, a sensor module 240, an input unit 250, a display 260, an interface 270, an audio module 280, a camera module 291, a power management module 295, a battery 296, an indicator 297, and a motor 298.

The AP 210 may drive an OS or an application to control a plurality of hardware or software elements connected to the AP 210, and perform various data processing including multimedia data and operations. The AP 210 may be implemented, for example, as a system on chip (SoC). According to an embodiment of the present disclosure, the AP 210 may further include at least one of a graphic processing unit (GPU) or image signal processor. The AP 210 may be implemented to include at least a portion (e.g., the cellular module 221) of the above-described elements. Also, the AP 210 may store data received from at least one of other elements or generated by at least one other element in a non-volatile memory.

The communication module 220 (e.g., the communication interface 160) may perform data transmission/reception in communication between the electronic device 201 and other electronic devices 102, 104 or the server 106 connected via a network. The communication module 220 includes a cellular module 221, a Wi-Fi module 223, a BT module 225, a GPS module 227, an NFC module 228, and a Radio Frequency (RF) module 229.

The cellular module 221 may provide voice communication, image communication, a short message service, or an Internet service, etc. via a communication network (e.g., Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), Global System for Mobile Communications (GSM)). Also, the cellular module 221 may perform authentication of an electronic device within a communication network using, for example, a subscriber identify module (e.g., a SIM card 224). The cellular module 221 may perform at least a portion of functions that may be provided by the AP 210. The cellular module 221 may include a communication processor (CP). Also, the cellular module 221 may be, for example, implemented as an SoC. Though elements such as the cellular module 221 (e.g., a communication processor), the memory 230, or the power management module 295, etc. are illustrated as elements separated from the AP 210 in FIG. 2, the AP 210 may be implemented to include at least a portion (e.g., the cellular module 221) of the above-described elements.

Each of the Wi-Fi module 223, the BT module 225, the GPS module 227, or the NFC module 228 may include, for example, a processor for processing data transmitted/received via a relevant module. Though the cellular module 221, the Wi-Fi module 223, the BT module 225, the GPS module 227, and the NFC module 228 are illustrated as separate blocks in FIG. 2, at least a portion (e.g., two or more elements) of the cellular module 221, the Wi-Fi module 223, the BT module 225, the GPS module 227, and the NFC module 228 may be included in one Integrated Circuit (IC) or an IC package. For example, at least a portion (e.g., a communication processor corresponding to the cellular module 221 and a Wi-Fi processor corresponding to the Wi-Fi module 223) of processors corresponding to each of the cellular module 221, the Wi-Fi module 223, the BT module 225, the GPS module 227, or the NFC module 228 may be implemented as one SoC.

The RF module 229 may perform transmission/reception of data, for example, transmission/reception of an RF signal. The RF module 229 may include, for example, a transceiver, a power amp module (PAM), a frequency filter, or a low noise amplifier (LNA), etc. Also, the RF module 229 may further include a part for transmitting/receiving an electromagnetic wave in free space in wireless communication, for example, a waveguide. Though FIG. 2 illustrates the cellular module 221, the Wi-Fi module 223, the BT module 225, the GPS module 227, and the NFC module 228 share one RF module 229, at least one of the cellular module 221, the Wi-Fi module 223, the BT module 225, the GPS module 227, or the NFC module 228 may perform transmission/reception of an RF signal via a separate RF module.

The SIM card 224 may be include a subscriber identify module, and may be inserted into a slot formed in a specific position of the electronic device. The SIM card 224 may include unique identify information (e.g., integrated circuit card identifier (ICCID)) or subscriber information (e.g., international mobile subscriber identity (IMSI)).

The memory 230 (e.g., the memory 130) includes a built-in memory 232 or an external memory 234. The built-in memory 232 may include, for example, at least one of a volatile memory (e.g., dynamic RAM (DRAM), static RAM (SRAM), synchronous dynamic RAM (SDRAM)) and a non-volatile memory (e.g., one time programmable ROM (OTPROM), programmable ROM (PROM), erasable and programmable ROM (EPROM), electrically erasable and programmable ROM (EEPROM), mask ROM, flash ROM, NAND flash memory, NOR flash memory, etc.).

According to an embodiment of the present disclosure, the built-in memory 232 may be a Solid State Drive (SSD). The external memory 234 may further include a flash drive, for example, compact flash (CF), secure digital (SD), micro secure digital (Micro-SD), mini secure digital (Mini-SD), extreme digital (xD), or a memory stick. The external memory 234 may be functionally connected with the electronic device 201 via various interfaces. The electronic device 201 may further include a storage device (or a storage medium) such as a hard drive.

The sensor module 240 may measure a physical quantity or detect an operation state of the electronic device 201, and convert the measured or detected information to an electric signal. The sensor module 240 includes at least one of a gesture sensor 240A, a gyro sensor 240B, an air pressure sensor 240C, a magnetic sensor 240D, an acceleration sensor 240E, a grip sensor 240F, a proximity sensor 240G, a color sensor 240H (e.g., RGB (red, green, blue) sensor), a biometric sensor 240I, a temperature/humidity sensor 240J, an illuminance sensor 240K, and an ultra violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, or a fingerprint sensor, etc. The sensor module 240 may further include a control circuit for controlling at least one sensor belonging thereto.

The input unit 250 includes a touch panel 252, a (digital) pen sensor 254, a key 256, and an ultrasonic input unit 258. The touch panel 252 may recognize a touch input using at least one of capacitive, resistive, infrared, or ultrasonic methods. Also, the touch panel 252 may further include a control circuit. A capacitive touch panel may perform detection by a physical contact or proximity recognition. The touch panel 252 may further include a tactile layer. In this case, the touch panel 252 may provide a tactile reaction to a user.

The (digital) pen sensor 254 may be implemented using, for example, a method which is the same as or similar to receiving a user's touch input, or using a separate sheet for detection. The key 256 may include, for example, a physical button, an optical key or keypad. The ultrasonic input unit 258 is a unit for recognizing data by detecting a sound wave using a microphone 288 in the electronic device 201 via an input tool generating an ultrasonic signal. The electronic device 201 may receive a user input from an external device (e.g., a computer or a server) connected to the communication module 220 using the communication module 220.

The display 260 (e.g., the display 150) includes a panel 262, a hologram device 264, and a projector 266. The panel 262 may be, for example, a liquid crystal display (LCD), or an active-matrix organic light-emitting diode (AM-OLED), etc. The panel 262 may be implemented as flexible, transparent, or wearable. The panel 262 may be configured as one module together with the touch panel 252. The hologram device 264 may show a three-dimensional image in the air using interference of light. The projector 266 may project light onto a screen to display an image. The screen may be positioned, for example, inside or outside the electronic device 201. The display 260 may further include a control circuit for controlling the panel 262, the hologram device 264, or the projector 266.

The interface 270 includes a high-definition multimedia interface (HDMI) 272, a universal serial bus (USB) 274, an optical interface 276, and a D-subminiature (D-sub) 278. The interface 270 may be included, for example, in the communication interface 160 illustrated in FIG. 1. Additionally or alternatively, the interface 270 may include, for example, a mobile high-definition link (MHL) interface, a secure digital (SD) card/multi-media card (MMC) interface, or an infrared data association (IrDA) standard interface.

The audio module 280 may convert a sound into an electric signal bidirectionally. At least a partial element of the audio module 280 may be included, for example, in the I/O interface 150 illustrated in FIG. 1. The audio module 280 processes sound information input or output via a speaker 282, a receiver 284, an earphone 286, or the microphone 288, etc.

The camera module 291 is a device that may shoot a still image and a moving picture. The camera module 291 may include one or more image sensors (e.g., a front sensor or a rear sensor), a lens, an image signal processor (ISP), or a flash (e.g., an LED or xenon lamp).

The power management module 295 may manage power of the electronic device 201. The power management module 295 may include, for example, a power management integrated circuit (PMIC), a charger integrated circuit (IC), or a battery or a battery gauge.

The PMIC may be mounted, for example, inside an integrated circuit or an SoC. A charging method may be classified into a wired charging method and a wireless charging method. The charging IC may charge a battery and prevent overvoltage or overcurrent from a charger. The charging IC may include a charging IC for at least one of the wired charging method and the wireless charging method. The wireless charging method may be, for example, a magnetic resonance method, a magnetic induction method, or an electromagnetic wave method, etc., and may additionally include a circuit for wireless charging, for example, a circuit such as a coil loop, a resonance circuit, or a rectifier, etc.

The battery gauge may measure, for example, a remaining charge of the battery 296, a voltage, a current, or a temperature while charging. The battery 296 may store or generate electricity, and supply power to the electronic device 201 using the stored or generated electricity. The battery 296 may include, for example, a rechargeable battery or a solar battery.

The indicator 297 may display a specific state of the electronic device 201 or a portion thereof (e.g., the AP 210), for example, a booting state, a message state, or a charging state, etc. The motor 298 may convert an electric signal into mechanical vibration. Though not shown, the electronic device 201 may include a processor (e.g., a GPU) for supporting a mobile TV. The processor for supporting the mobile TV may process media data corresponding to standards such as digital multimedia broadcasting (DMB), digital video broadcasting (DVB), or Mediaflo™, etc.

The aforementioned elements of the electronic device according to various embodiments of the present disclosure may be constructed by one or more components, and the name of the corresponding element may vary with a type of electronic device. The electronic device may include at least one of the aforementioned elements. Some elements may be omitted or other additional elements may be further included in the electronic device. Further, some of the components of the electronic device may be combined to form a single entity, and thus, may equivalently execute functions of the corresponding elements prior to the combination.

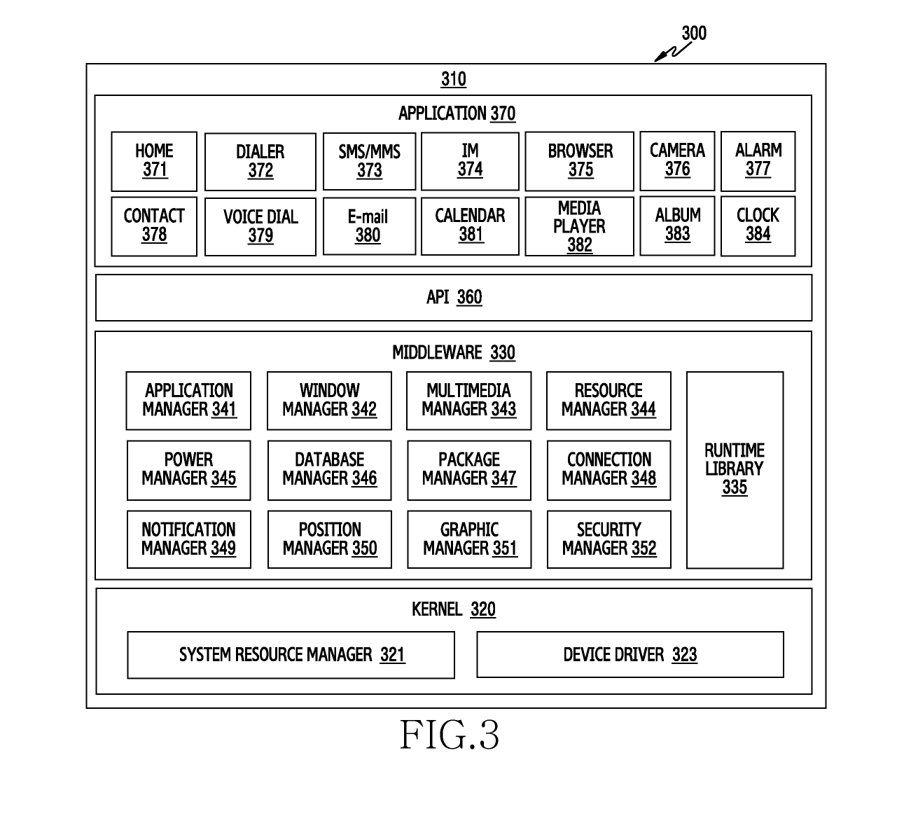

FIG. 3 is a block diagram 300 of a program module 310 according to various embodiments of the present invention.

The program module 310 (for example, the programs 140) may include an Operating System (OS) for controlling resources related to the electronic device (for example, the electronic device 101) and/or various applications (for example, the application program 147) executed in the operating system. The operating system may be, for example, Android™, IOS™, Windows™, Symbian™, Tizen™, Bada™, and the like.

The programming module 310 includes a kernel 320, middleware 330, an API 360, and/or applications 370. At least some of the program module 310 may be preloaded in the electronic device or downloaded from the server 106.

The kernel 320 (for example, the kernel 141 of FIG. 1) includes a system resource manager 321 and a device driver 323. The system resource manager 321 may control, allocate, or collect the system resources. The system resource manager 321 may include a process management unit, a memory management unit, or a file system management unit. The device driver 323 may include, for example, a display driver, a camera driver, a Bluetooth driver, a shared-memory driver, a USB driver, a keypad driver, a WiFi driver, an audio driver, or an Inter-Process Communication (IPC) driver.

The middleware 330 may provide a function required by the applications 370 in common or provide various functions to the applications 370 through the API 360 so that the applications 370 may efficiently use limited system resources within the electronic device. According to an embodiment of the present disclosure, the middleware 330 (for example, the middleware 143) includes a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module that a compiler uses to add new functions through a programming language while the application 370 is executed. The runtime library 335 may perform input/output management, memory management, or an arithmetic function.

The application manager 341 may manage, for example, a life cycle of at least one of the applications 370. The window manager 342 may manage Graphical User Interface (GUI) resources used by a screen. The multimedia manager 343 may provide formats required for the reproduction of various media files, and may perform an: encoding or decoding of the media file by using a codec suitable for the corresponding format. The resource manager 344 may manage resources such as source code, memory, and storage space of at least one of the applications 370.

The power manager 345 may operate together with a Basic Input/Output System (BIOS) to manage a battery or power and may provide power information required for the operation of the electronic device. The database manager 346 may generate, search for, or change a database to be used by at least one of the applications 370. The package manager 347 may manage the installation or the updating of applications distributed in the form of package file.

The connectivity manager 348 may manage wireless connection of, for example, Wi-Fi or Bluetooth. The notification manager 349 may display or notify a user of an event such as an arrival message, proximity notification, and the like in such a way that does not disturb a user. The location manager 350 may manage location information of the electronic device. The graphic manager 351 may manage graphic effects to be provided to a user and user interfaces related to the graphic effects. The security manager 352 may provide all security functions required for system security or user authentication. When the electronic device 101 has a call function, the middleware 330 may further include a telephony manager for managing a voice call function or a video call function of the electronic device.

The middleware 330 may include a middleware module for forming a combination of various functions of the aforementioned components. The middleware 330 may provide modules specialized according to types of operating systems in order to provide differentiated functions. Further, the middleware 330 may dynamically remove some of the existing components or add new components.

The API 360 (for example, the API 145) is, for example, a set of API programming functions, and a different configuration thereof may be provided according to an operating system. For example, Android™ or iOS™ may provide one API set per platform, and Tizen™ may provide two or more API sets per platform.

The applications 370 includes one or more applications which may provide functions such as home 371, dialer 372, SMS/MMS 373, Instant Message (IM) 374, browser 375, camera 376, alarm 377, contacts 378, voice dialer 379, email 380, calendar 381, media player 382, album 383, clock 384, health care (for example, measure exercise quantity or blood sugar), or environment information (for example, atmospheric pressure, humidity, or temperature information).

According to an embodiment of the present disclosure, the applications 370 may include an application (hereinafter, referred to as an “information exchange application”) supporting information exchange between the electronic device 101 and an external electronic device 102,104. The information exchange application may include, for example, a notification relay application for transferring predetermined information to an external electronic device or a device management application for managing an external electronic device.

For example, the notification relay application may include a function of transferring, to the external electronic device, notification information generated from other applications of the electronic device 101 (for example, an SMS/MMS application, an e-mail application, a health management application, or an environmental information application). Further, the notification relay application may receive notification information from, for example, a control device and provide the received notification information to the user. The device management application may manage (for example, install, delete, or update), for example, a function for at least a part of the external electronic device communicating with the electronic device (for example, turning on/off the external electronic device itself (or some elements thereof) or adjusting brightness (or resolution) of a display), applications executed in the external electronic device, or services provided from the external electronic device (for example, a telephone call service or a message service).

According to an embodiment of the present disclosure, the applications 370 may include an application (for example, health management application) designated according to attributes of the external electronic device (for example, attributes of the electronic device such as the type of electronic device which corresponds to a mobile medical device). The applications 370 may include an application received from the external electronic devices (for example, the server 106 or the external electronic devices 102, 104). The applications 370 may include a preloaded application or a third party application which may be downloaded from the server. The names of the components of the program module 310 illustrated in FIG. 3 may vary according to the type of operating system.

According to various embodiments of the present disclosure, at least some of the programming module 310 may be implemented by software, firmware, hardware, or a combination of two or more thereof. At least some of the programming module 310 may be implemented (for example, executed) by the processor (for example, the application program). At least some of the programming module 310 may include, for example, a module, program, routine, sets of instructions, or process for performing one or more functions.

The term “module” as used in the present disclosure may refer to a unit including a combination of hardware, software, or firmware. The term “module” may be interchangeably used with the terms unit, logic, logical block, component, or circuit, etc. A “module” may be a minimum unit of an integrally configured part or a portion thereof. A “module” may be a minimum unit performing one or more functions or a portion thereof. A “module” may be mechanically or electronically implemented. For example, a “module” may include at least one of an application-specific integrated circuit (ASIC) chip, field-programmable gate arrays (FPGAs), or a programmable-logic device which are known, or to be developed in the future, and perform certain operations.

According to various embodiments of the present disclosure, at least a portion of a device (e.g., modules or functions thereof) or a method (e.g., operations) according to the present disclosure may be implemented as an instruction stored in a computer-readable storage media, for example, in the form of a programming module. An instruction, when executed by one or more processors (e.g., the processor 120), may allow the one or more processors to perform a function corresponding to the instruction. The computer-readable storage media may be, for example, the memory 130. At least a portion of a programming module may be implemented (e.g., executed) by, for example, the processor 120. At least a portion of the programming module may include, for example, a module, a program, a routine, sets of instructions, or a process, etc. for performing one or more functions.

The computer-readable storage media may include a hard disk, a magnetic media such as a floppy disk and a magnetic tape, Compact Disc Read Only Memory (CD-ROM), optical media such as Digital Versatile Disc (DVD), magneto-optical media such as a floptical disk, and a hardware device specially configured for storing and performing a program instruction (e.g., a programming module) such as Read Only Memory (ROM), Random Access Memory (RAM), a flash memory, etc. Also, the program instruction may include not only a machine language code generated by a compiler but also a high-level language code executable by a computer using an interpreter, etc. The above-described hardware device may be configured to operate as one or more software modules in order to perform an operation of the present disclosure.

A module or a programming module according to an embodiment of the present disclosure may include at least one of the above-described elements, omit a portion thereof, or further include additional elements. Operations performed by a module, a programming module, or other elements may be executed in a sequential, parallel, or heuristic method. Also, a portion of the operations may be executed in a different sequence, omitted, or other operations may be added.

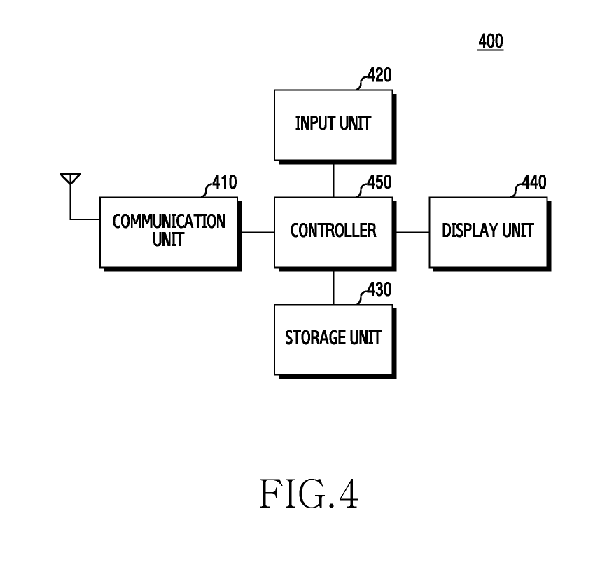

FIG. 4 is a block diagram illustrating an electronic device according to various embodiments of the present disclosure.

Referring to FIG. 4, an electronic device 400 according to various embodiments of the present disclosure includes a communication unit 410, an input unit 420, a storage unit 430, a display unit 440, and a controller 450.

The communication unit 410 (for example, the communication interface of FIG. 1) may perform communication in the electronic device 400. The communication unit 410 may communicate with an external device through various communication schemes. The communication unit 410 may perform at least one of wireless communication and wired communication. To this end, the communication unit 410 may access at least one of a mobile communication network and a data communication network. Alternatively, the communication unit 410 may perform short range communication. For example, the external device may include an electronic device, a base station, a server, and/or a satellite. Further, the communication scheme may include Long Term Evolution (LTE), Wideband Code Division Multiple Access (WCDMA), Global System for Mobile communications (GSM), Wi-Fi, Bluetooth, and/or Near Field Communication (NFC).

The input unit 420 (for example, the input/output interface of FIG. 1) may generate input data in the electronic device 400. The input unit 420 may generate the input data in accordance with a user input of the electronic device 400. The input unit 420 may include at least one input means. The input unit 120 may include a key pad, a dome switch, a physical button, a touch panel, a jog & shuttle, and/or a sensor. The input unit 420 may generate input data for setting a display area in which an alternative screen is displayed and/or a security application, and an input for replacing an execution screen with a predetermined alternative screen.

The storage unit 430 (for example, the memory 130 of FIG. 1) may store operation programs of the electronic device 400. The storage unit 430 may store a program (or application) for executing various functions. Further, the storage unit 430 may store data generated while each of the functions is performed. The data stored in the storage unit 430 may be information associated with conditions (for example, a predetermined time, a touch input, a connection with an external device, turning on the screen after turning off, data reception, a key input, and an eye gaze direction) for displaying the alternative screen. Further, the storage unit 430 may store information on the area in which the alternative screen is displayed and/or the security application.

The display unit 440 (for example, the display 160 of FIG. 1) may output display data. The display unit 440 may display a background screen. The display unit 440 may include a Liquid Crystal Display (LCD), a Light Emitting Diode (LED) display, an Organic LED (OLED) display, a Micro ElectroMechanical System (MEMS) display, and an electronic paper display. The display unit 440 may be coupled with the input unit 420 to be implemented as a touch screen. In this case, the display unit 440 may detect an input for setting the display area in which the alternative screen is displayed and/or the security application.

The controller 450 (for example, the processor 120 of FIG. 1) may control the general operation in the electronic device 400. When a security function is activated, the controller 450 may stop displaying a security area and/or an execution screen (in other words, a security execution screen) of the security application. The controller 450 may replace the execution screen displayed in the security area with a predetermined alternative screen. Further, the controller 450 may process a non-security execution screen operating in a background mode while the security area operates in a foreground mode. Further, the controller 450 may process a security execution screen displayed in a non-security area to be displayed in the security area.

An electronic device for controlling a screen according to various embodiments of the present disclosure may include a display unit for displaying at least two execution screens, and a controller for identifying an execution screen associated with security among execution screens displayed in accordance with activation of a security function and stopping displaying at least some of the execution screen associated with the security.

According to various embodiments of the present disclosure, the security function may be activated based on conditions corresponding to at least one of a predetermined time, a connection with an external device, turning on of a screen after turning off, data reception, a key input, and eye gaze direction.

According to various embodiments of the present disclosure, the controller may process the execution screen associated with the security to not occupy a display area. For example, the controller may process the execution screen associated with the security to not be displayed.

According to various embodiments of the present disclosure, the controller may replace the execution screen associated with the security with a predetermined screen. For example, the predetermined screen may include at least one of a lock screen, a mosaic screen, an execution screen having changed attribute information, and a screen designated by a user.

According to various embodiments of the present disclosure, the controller may define at least some of the display unit as a security area and move the execution screen associated with the security to the defined security area.

According to various embodiments of the present disclosure, the controller may switch the execution screen associated with the security to a background mode.

According to various embodiments of the present disclosure, the controller may stop transmission of the execution screen associated with the security in accordance with a connection with an external device.

According to various embodiments of the present disclosure, the controller may display received data through a display area corresponding to a defined security area in accordance with data reception from an external device.

According to various embodiments of the present disclosure, the execution screen associated with the security may be related to an application selected based on at least one of a user's input, attributes of an application, and a use pattern of an application.

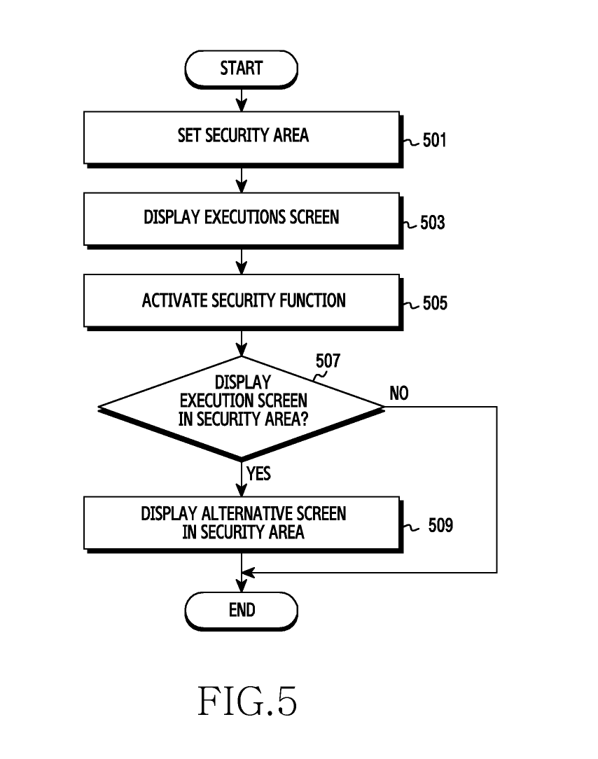

FIG. 5 is a flowchart illustrating a screen control process of the electronic device 101 according to various embodiments of the present disclosure.

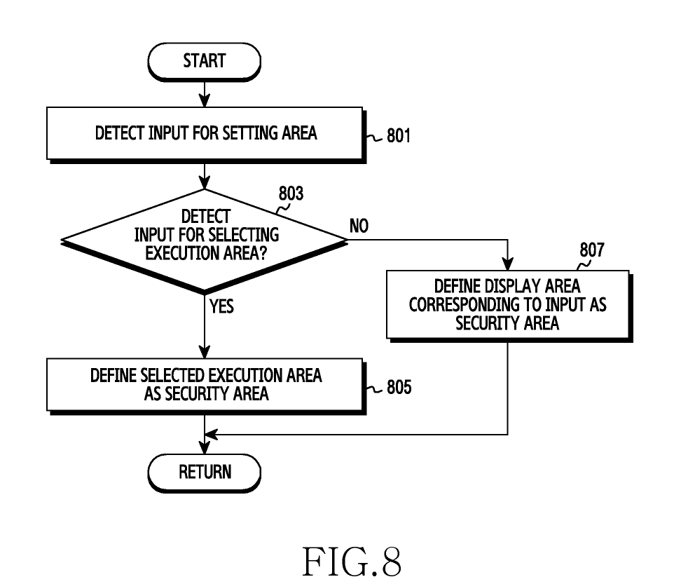

In step 501, the electronic device 101 sets a security area in the display. The security area may be an area in which an alternative screen is displayed when a condition is met. Further, displaying the alternative screen may mean stopping displaying of an execution screen located in a security area. The electronic device 101 may set the security area in the display by using a process of FIG. 8.

In step 503, the electronic device 101 displays the execution screen. The execution screen may be an operation screen of a function (for example, application) executed by the electronic device 101. The electronic device 101 may simultaneously display a plurality of execution screens.

In step 505, the electronic device 101 activates a security function. According to various embodiments of the present disclosure, the electronic device 101 may detect a user's eyes, and when the user's eyes are not detected, activate the security function. For example, when the user does not keep his/her eyes on the displayed execution screen, the security function may be activated. The electronic device 101 may activate the security function when an input is not detected for a predetermined time, when a time determined to perform the security function is detected, or when an authentication operation is performed. The electronic device 101 may activate the security function in response to detection of at least one of a connection with an external device, an input of a hard key (for example, a power button, a volume button, or a home button), an input of a soft key, and turning on of the screen after turning off.

In step 507, the electronic device 101 determines whether at least one execution screen is displayed through the predetermined security area. According to an embodiment of the present disclosure, the electronic device 101 may determine whether the execution screen is displayed through the execution area selected as the security area or whether the execution area is located in the display area selected as the security area. Further, the electronic device 101 may determine whether the predetermined execution screen (for example, execution screen related to the security) is displayed through the security area.

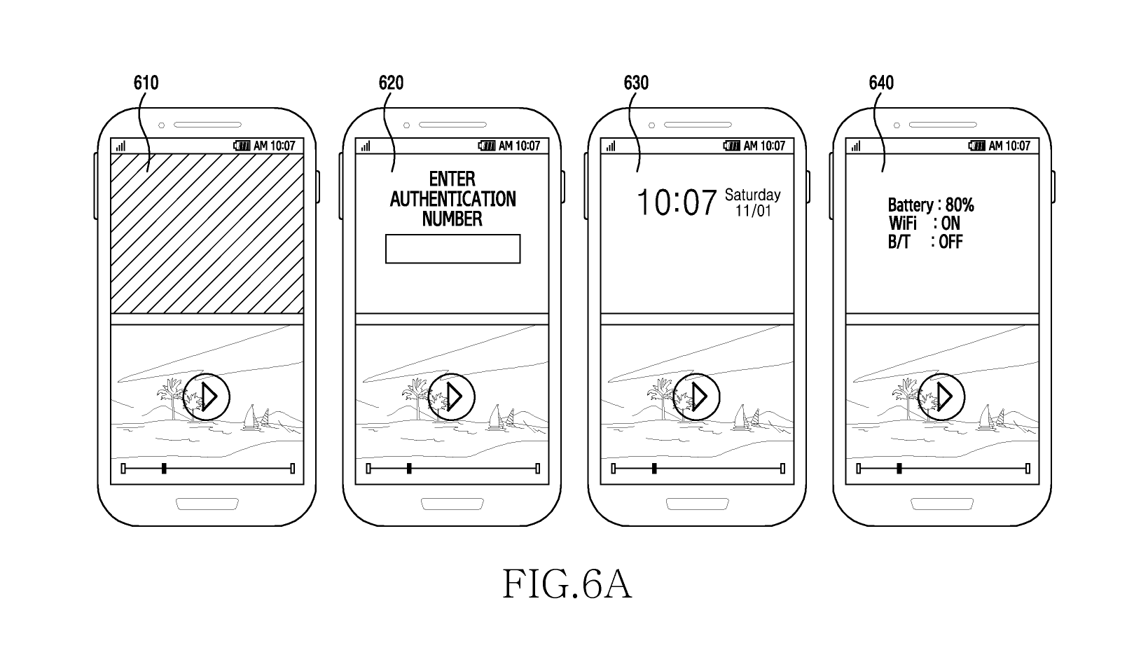

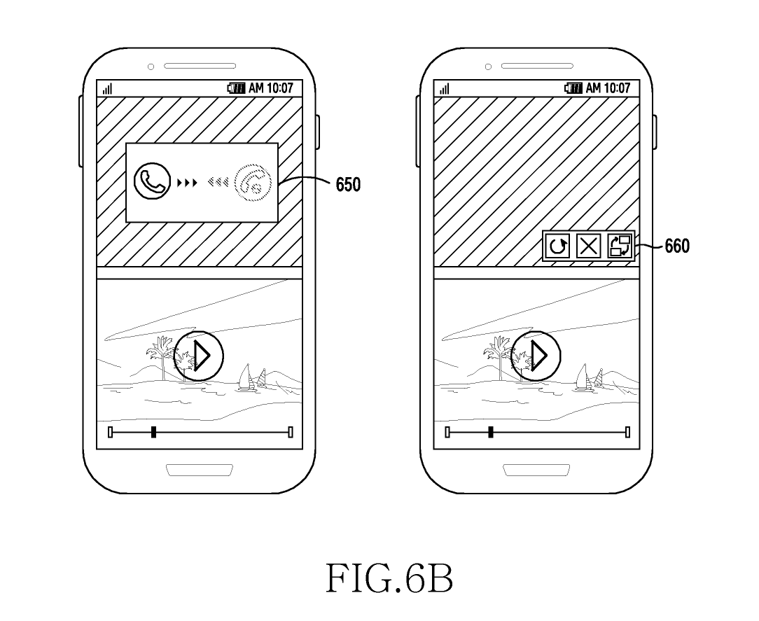

In step 509, a predetermined alternative screen is displayed in the security area in response to the displaying of the execution screen through the security area. The electronic device 101 according to various embodiments of the present disclosure may display the alternative screen in the security area to stop displaying the execution screen through the security area as illustrated in FIGS. 6A and 6B.

FIGS. 6A and 6B illustrate examples for describing a process in which the electronic device 101 displays an alternative screen in a security area according to various embodiments of the present disclosure.

The electronic device 101 may display the alternative screen in the security area to stop displaying the execution screen through the security area as illustrated in FIG. 6A. For example, the electronic device 101 may display the alternative screen by changing attributes of at least some of the displayed execution screen. The attributes may be associated with at least one of a brightness, area, shape, and color of the screen.

The electronic device 101 may display the alternative screen by changing at least some of the execution screen into a predetermined screen. The electronic device 101 may display, for example, a mosaic screen 610 in the security area. Further, when an input, which meets the condition, is detected in a state where the alternative screen is displayed, the electronic device 101 may stop displaying the alternative screen and display the execution screen through the security area.

The electronic device 101 may display the alternative screen by displaying a lock screen 620, which requires an authentication, in the security area. The electronic device 101 may stop displaying the alternative screen in response to detection of an input of authentication information that meets the condition.

The electronic device 101 may display the alternative screen by displaying at least some of a main screen 630 in the security area. The electronic device 101 may also display information indicating that the main screen is used as the alternative screen.

The electronic device 101 may display the alternative screen by displaying a state information screen 640 in the security area. According to an embodiment of the present disclosure, the state information screen 640 may include a short-range communication setting state and a battery charging state.

According to various embodiments of the present disclosure, the electronic device 101 may display the alternative screen by displaying additional information in a state where the alternative screen is displayed as illustrated in FIG. 6B. The additional information may include notification information (for example, a call reception information, a message reception information, and application update information) and information on an execution screen (in other words, the execution screen located in the security area), which is not displayed due to the alternative screen as indicated by reference numeral 650. Further, the additional information may include a menu for controlling execution information, which is not displayed due to the alternative screen and a menu for stopping displaying the alternative screen and displaying the execution screen as indicated by reference numeral 660.

The electronic device 101 may display the alternative screen by displaying information related to at least one of an execution frequency, an execution time, and an execution period of the application in the security area. Further, the electronic device 101 may display the alternative screen by displaying information designated by the user (for example, a stored image, a clock screen, a weather widget, and a media reproducer) in the security area.

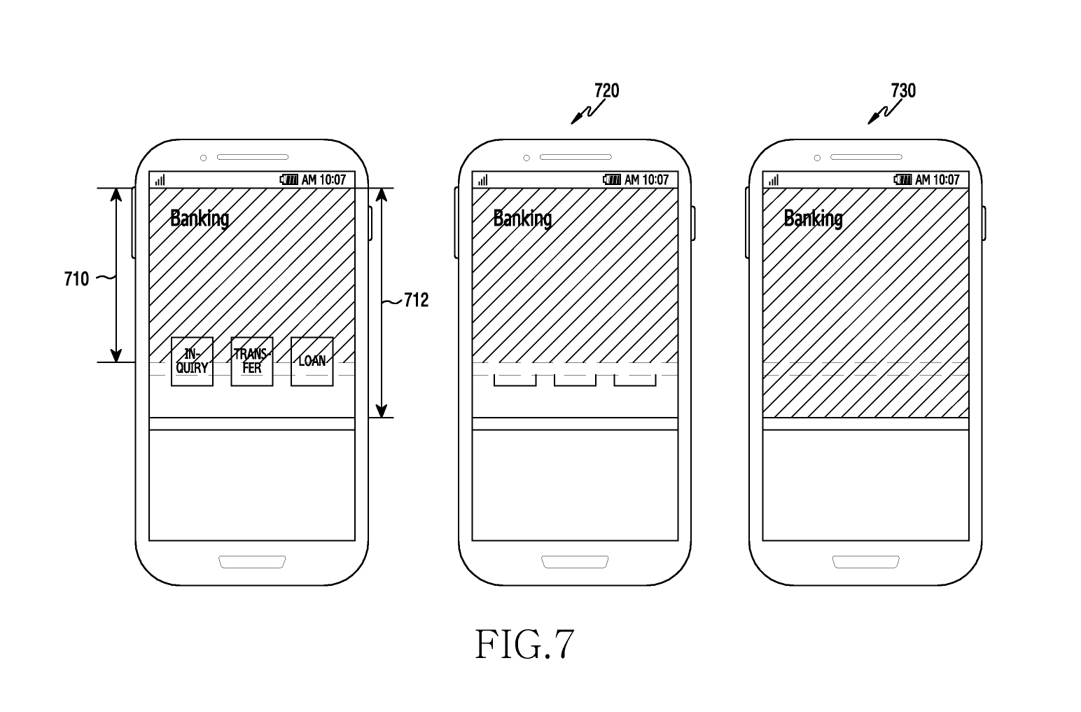

FIG. 7 illustrates an example for describing another process in which the electronic device 101 displays the alternative screen in the security area according to various embodiments of the present disclosure.

According to various embodiments of the present disclosure, the electronic device 101 may display the alternative screen based on at least one of a size of the displayed area designated as the security area and/or a size of the execution area. For example, as illustrated in FIG. 7, when an execution area 712 is displayed while being escaped from a display area 710 (for example, security area) designated as the security area (a size of the execution area 712 is larger than a size of the display area 710 designated as the security area), the electronic device 101 may display an alternative screen 720 corresponding to a size of the display area 710 or an alternative screen 730 corresponding to a size of the execution area 712. Further, the size of the execution area may be changed to correspond to the size of the display area set as the security area.

FIG. 8 is a flowchart illustrating a process of an operation in which the electronic device 101 sets the security area according to an embodiment of the present disclosure.

In step 801, the electronic device 101 detects an input for setting an area. The electronic device 101 may detect an input for setting at least some of the display area of the electronic device 101 as the security area. For example, the input for setting the area may be an input for setting at least one of the execution area and the display area. The execution area may be an area in which each execution screen corresponding to a function (for example, application) executed by the electronic device 101, and may include, for example, a window, a frame, and a layer. Further, the display area may be an area of the entire display in which the execution screen may be displayed. The display area may simultaneously display a plurality of execution areas and each of the execution screens may be displayed while overlapping at least some of another execution screen. The electronic device 101 may detect an input for setting an area by using a body part (for example, a finger) or an electronic pen. The electronic device 101 may set a dependent screen of the execution screen as the security area. The dependent screen may be at least one of a higher depth screen (for example a previous screen) and a lower depth screen (for example, a next screen) of the execution screen. The depth of the screen refers to the particular layer of the screen when multiple screen layers are displayed. For example, when the execution screen is a browser screen, the dependent screen of the execution screen may be a previous page or a next page.

In step 803, the electronic device 101 determines whether an input for selecting the execution area is detected or an input for selecting the display area is detected.

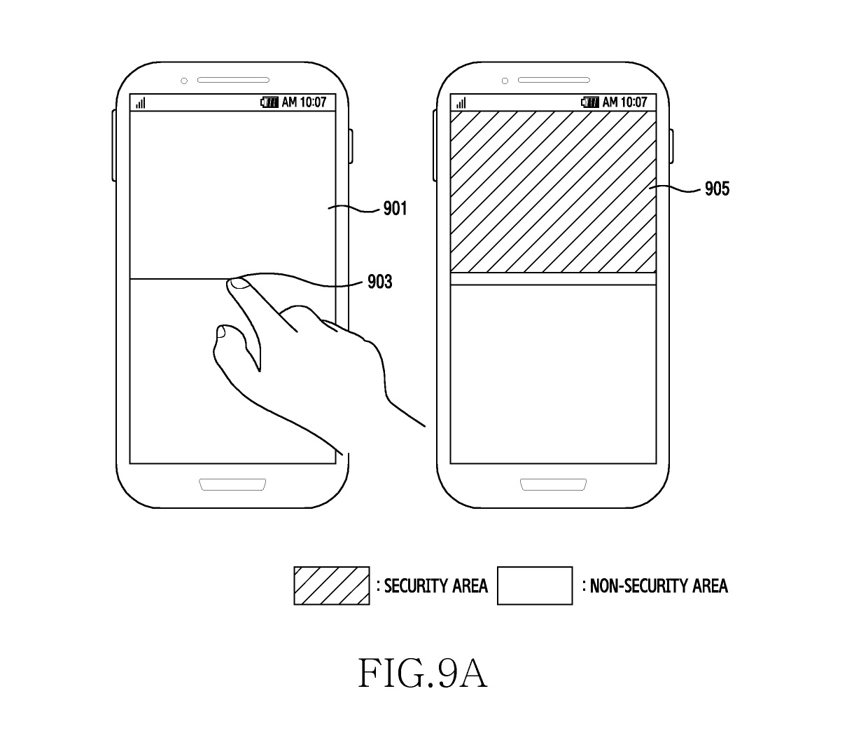

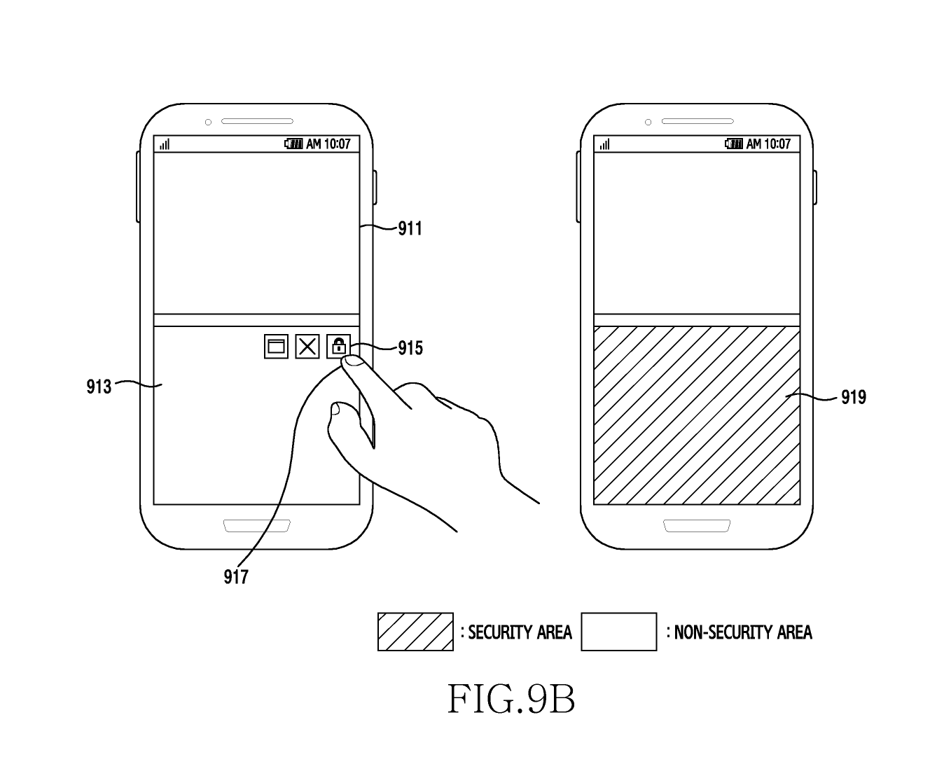

When it is determined that the input for setting the display area is detected, the electronic device 101 defines at least some of the display area corresponding to the input as the security area in step 807. The input for setting the display area may be a touch input (for example, a drag input) that defines the area. For example, as illustrated in FIG. 9A, the electronic device 101 detects a touch input 903 on a display 901 and sets display area 905 of the identified display 901 as the security area based on the input. Further, the electronic device 101 may define the remaining areas except for the security area as a non-security area. The electronic device 101 may present a predefined form of the security area and set the security area based on the selected form. For example, the electronic device 101 may split the display into a plurality of areas and provide information on the split areas to receive a selection of at least one of the split areas to be used as the security area.

When it is determined that the input for selecting the execution area is detected, the electronic device 101 defines the selected execution area as the security area in step 805. For example, as illustrated in FIG. 9B, the electronic device 101 may load a control menu for at least one execution area 913 displayed on a display 911. The control menu may include a menu for changing a location of the execution area, a menu for changing a size of the execution area, and a menu for stopping displaying the execution area, and may further include a menu 915 for setting the execution area as the security area. When an input 917 for selecting the menu 915 for setting the execution area as the security area is detected in a state where the control menu is loaded, the electronic device 101 may set an execution area 913 associated with the control menu as a security area 919. According to various embodiments of the present disclosure, a form (for example, a location or a size) of the execution area set as the security area may be changed, and the electronic device 101 may display an alternative screen corresponding to the changed form.

The electronic device 101 may set the execution area in which a predefined input is detected as the security area. In this case, the electronic device 101 may not load the control menu for the execution area. For example, the electronic device 101 may set an execution area in which continuous touches are detected among the plurality of execution areas as the security area.

The electronic device 101 according to various embodiments of the present disclosure may return to the screen control process of FIG. 5 after defining the execution area as the security area in step 805. Alternatively, the electronic device 101 may return to the screen control process of FIG. 5 after defining the display area as the security area in step 807.

The electronic device 101 according to various embodiments of the present disclosure may set the security area based on the user's input as illustrated in FIG. 8, but may also set the security area based on currently displayed information (for example, the location of the execution screen associated with the security) regardless of the user's input and inform the user of the setting of the security area.

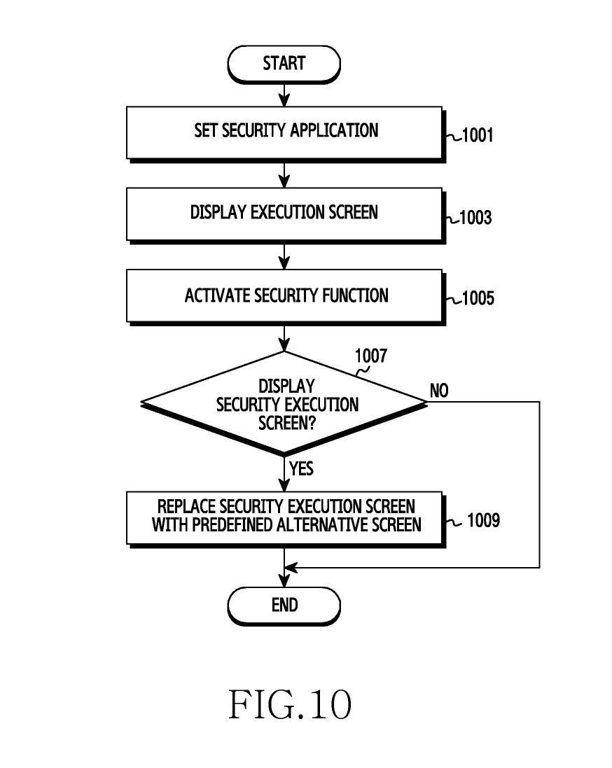

FIG. 10 is a flowchart illustrating a screen control process of the electronic device 101 according to various embodiments of the present disclosure.

In step 1001, the electronic device 101 sets a security application. The security application may be an application in which an execution screen stops being displayed when a condition is met. For example, when a security function is executed, the execution screen of the security application may be replaced with a predetermined alternative screen.

In step 1003, the electronic device 101 displays the execution screen. For example, the electronic device 101 may display one or more execution screens. When a plurality of execution screens are displayed, the electronic device 101 may process at least one execution screen to not occupy a display area. That is, the execution screen, which does not occupy the display area, may operate in a background mode.

In step 1005, the electronic device 101 activates a security function. According to various embodiments of the present disclosure, the electronic device 101 may activate the security function based on the condition corresponding to at least one of a predetermined time, a touch input, a connection with an external device, turning on of the screen after turning off, data reception, a key input, eye gaze direction recognition, biometric information recognition (for example, fingerprint recognition, iris recognition, voice recognition, and smell recognition).

In step 1007, the electronic device 101 determines whether a security execution screen, in other words, the execution screen of the security application is displayed.

In step 1009, the electronic device 101 displays a predetermined alternative screen instead of the execution screen of the security application in response to the displaying of the execution screen of the security application in step 1009. According to various embodiments of the present disclosure, the electronic device 101 may process the execution screen of the security application to operate in the background mode to make the execution screen of the security application not occupy the display area. Further, the electronic device 101 may process a non-security screen operating in the background mode to operate in the foreground mode to make the execution screen of the security application not occupy the display area.

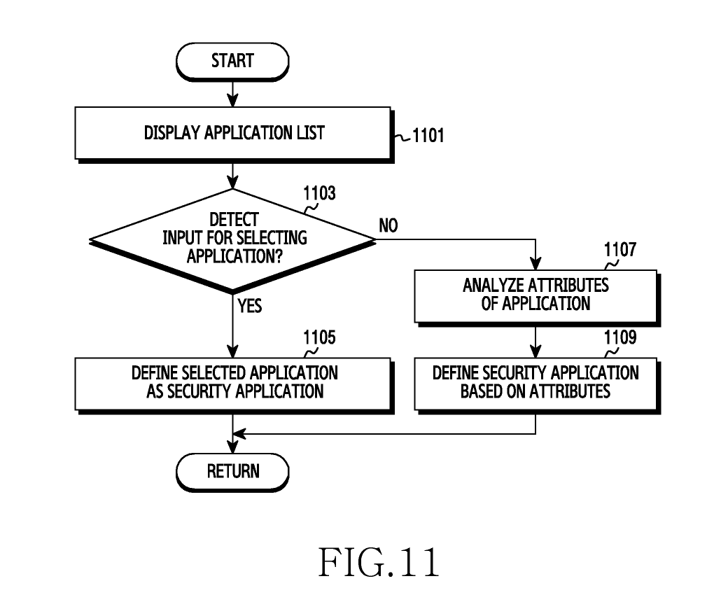

FIG. 11 is a flowchart illustrating a process of an operation for setting the security application in the electronic device according to an embodiment of the present disclosure.

In step 1101, the electronic device 101 displays at least one piece of application information. For example, the electronic device 101 displays the application information in a list form and detects an input related to a selection of an application in step 1103.

When the input related to the selection of the application is detected, the electronic device 101 defines the selected application as the security application in step 1105. For example, the electronic device 101 may detect a selection of at least one displayed application and define the application related to the selection as the security application.

When the input related to the selection of the application is not detected, the electronic device 101 may analyze attributes of the applications in step 1107, and define the security application based on the analyzed attributes in step 1109. According to various embodiments of the present disclosure, when the application is installed regardless of the input related to the selection of the application, the electronic device 101 may define the security application based on attributes when a security information setting is requested by the user. The electronic device 101 may stop defining the security application when a predetermined time period passes. Further, the electronic device 101 may stop defining the security application when the security application is executed a predetermined number of times or more.

In step 1105, the electronic device 101 returns to the screen control process of FIG. 10 after defining the security application. Alternatively, the electronic device 101 may return to the screen control process of FIG. 10 after defining the security application based on the analysis of the attributes in step 1109.

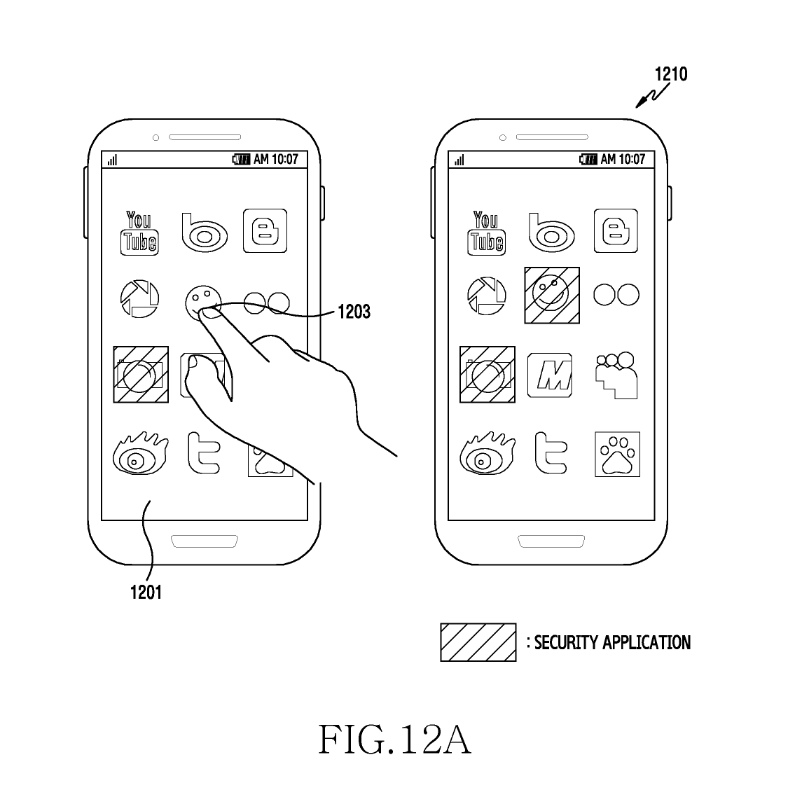

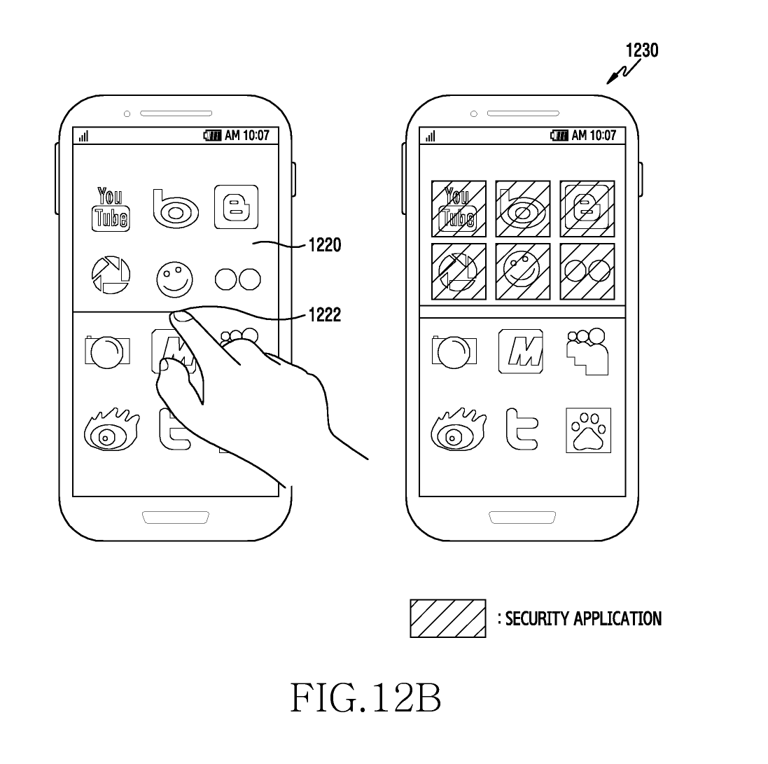

FIGS. 12A and 12B illustrate examples for describing a process of the electronic device 101 for defining the security application based on an input related to the selection of the application according to various embodiments of the present disclosure.

According to various embodiments of the present disclosure, the electronic device 101 may display information on at least one installed application, for example, an application list. Further, the electronic device 101 may detect an input 1203 for selecting an application and define the selected application according to an input among the applications included in a list 1201 as the security application as indicated by reference numeral 1210 of FIG. 12A.

According to various embodiments of the present disclosure, the electronic device 101 may define an application included in a displayed application list 1220, which is located in an area defined by an input 1222 as the security area as indicated by reference numeral 1230 of FIG. 12B.

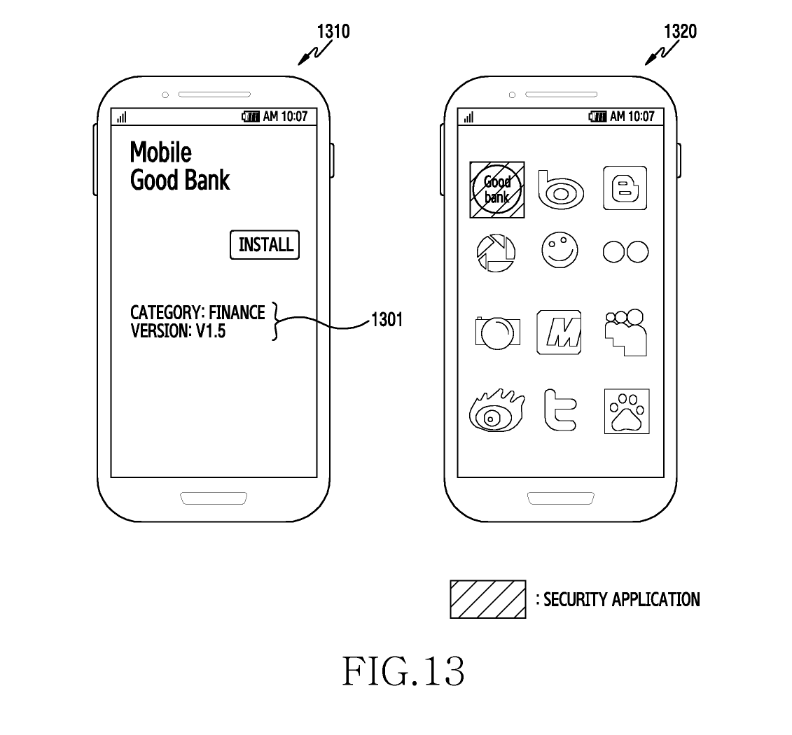

FIG. 13 illustrates an example for describing a process of the electronic device 101 for defining the security application based on attributes of the application according to various embodiments of the present disclosure.

According to various embodiments of the present disclosure, the electronic device 101 may analyze an application installed in the electronic device 101 or a category 1301 of the application installed in the electronic device 101 as indicated by reference numeral 1310, and set an application included in a predefined category (for example, a finance category or a chatting category) as the security application as indicated by reference numeral 1320.

According to another embodiment of the present disclosure, the electronic device 101 may set an application, which passes an authentication operation, as the security application. The electronic device 101 may set the application as the security application according to attributes (for example, personal profile information) of displayed information. The electronic device 101 may set the security application based on a use pattern of the application. For example, the use pattern may be associated with an operation for moving the execution screen to the security area. The electronic device 101 may set the security application based on at least one of a use frequency, a priority, and an importance of the application.

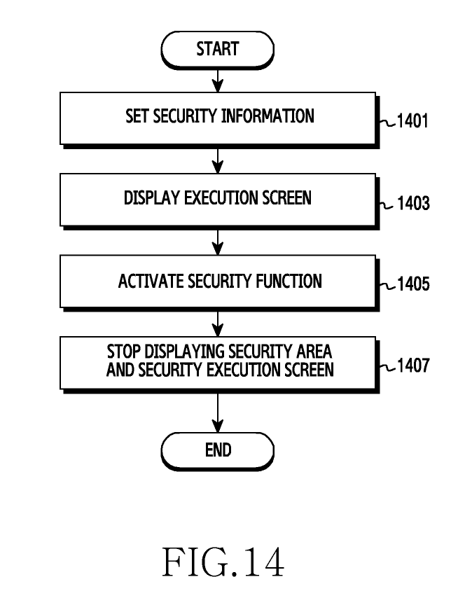

FIG. 14 is a flowchart illustrating a screen control process of the electronic device 101 according to various embodiments of the present disclosure.

In step 1401, the electronic device 101 sets security information. The security information may be associated with a security area of the display and/or a security application. The electronic device 101 sets the security information by performing step 501 of FIG. 5 and/or step 1001 of FIG. 10.

In step 1403, the electronic device 101 displays the execution screen. According to various embodiments of the present disclosure, the electronic device 101 may display at least one security execution screen (for example, execution screen of the security application) or at least one non-security execution screen (for example, execution screen of the non-security application), or simultaneously display the security execution screen and the non-security execution screen.

The electronic device 101 activates a security function in step 1405, and stops displaying the security area and/or the execution screen of the security application in step 1407. According to various embodiments of the present disclosure, the electronic device 101 may stop displaying the execution screen related to the security application defined for the displayed execution screen. The electronic device 101 may stop defining and displaying the execution screen of the non-security application, which is displayed in the security area, as the execution screen of the security application. Further, the electronic device 101 may move the execution screen of the security area to the non-security area or process the execution screen of the security application to operate in the background mode without occupying the display area in order to stop displaying the execution screen related to the security. Further, the electronic device 101 may process the execution screen of the non-security application to operate in the foreground mode to occupy the display area.

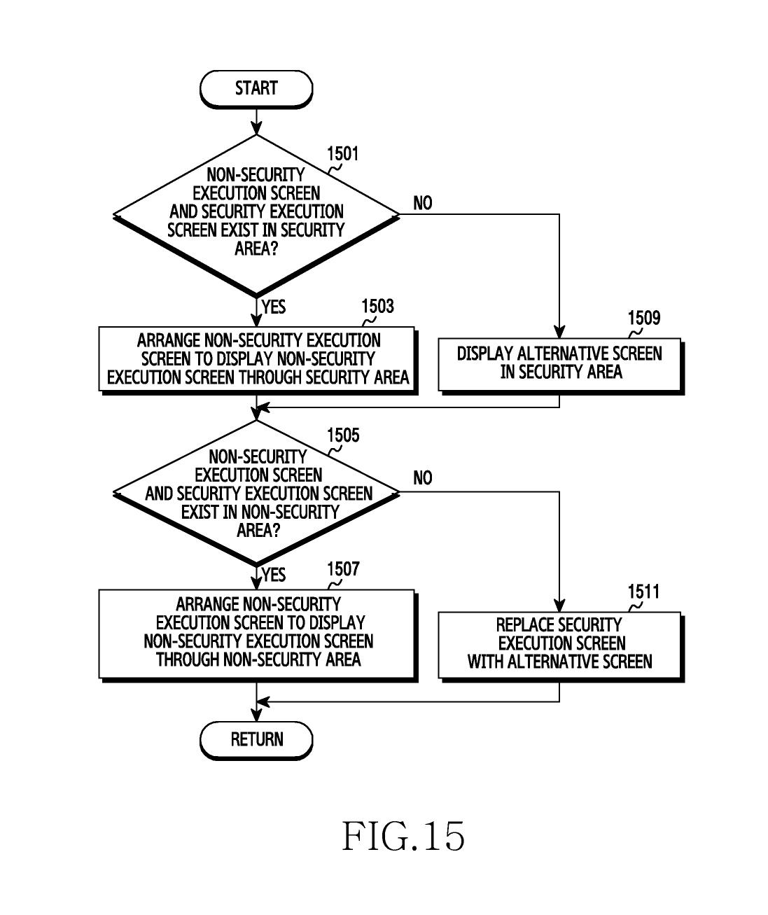

FIG. 15 is a flowchart illustrating a process of the electronic device 101 for stopping displaying the execution screen of the security application according to various embodiments of the present disclosure.

In step 1501, it is determined whether a non-security execution screen and a security execution screen exist in the security area. According to various embodiments of the present disclosure, the electronic device 101 may identify whether at least one non-security execution screen and at least one security execution screen exist in a defined security area. For example, a situation in which the non-security execution screen and the security execution screen exist in the security area may be a situation in which the non-security execution screen operates in the foreground to occupy the display area corresponding to the defined security area and the security execution screen operates in the background mode to not occupy the display area corresponding to the defined security area. The situation may be the security execution screen operates in the foreground mode and the non-security execution screen operates in the background mode. Further, the situation may be the security execution screen and the non-security execution screen are in the security area or the non-security area.

In step 1503, the electronic device 101 arranges the non-security execution screen to display the non-security execution screen through the security area in accordance with the existence of the non-security execution screen and the security execution screen in the security area. For example, the electronic device 101 may process the non-security execution screen to occupy the display area corresponding to the security area and, accordingly, the security execution screen may not occupy the display area corresponding to the security area. That is, the security execution screen operates in the background mode.

In step 1505, the electronic device 101 displays a defined screen (for example, an alternative screen) in the security area in accordance with the non-existence of the non-security execution screen and the security execution screen in the security area. For example, when only the security execution screen exists in the security area, the electronic device 101 may change the security execution screen to a mosaic screen or change and display attribute information on the execution screen.

After displaying the non-security execution screen through the security area in step 1503 or displaying the alternative screen in the security area in step 1509, the electronic device 101 determines whether the non-security execution screen and the security execution screen exist in the non-security area in step 1505. According to various embodiments of the present disclosure, the electronic device 101 may identify whether at least one non-security execution screen and at least one security execution screen exist in a defined non-security area. For example, a situation in which the non-security execution screen and the security execution screen exist in the security area may be the non-security execution screen operates in the foreground mode to occupy the display area corresponding to the defined non-security area and the security execution screen operates in the background mode to not occupy the display area corresponding to the defined non-security area. The situation may be the security execution screen operates in the foreground mode and the non-security execution screen operates in the background mode. Further, the situation may be the security execution screen and the non-security execution screen exist in the security area or the non-security area.

In step 1507, the electronic device 101 arranges the non-security execution screen to display the non-security execution screen through the non-security area in accordance with the existence of the non-security execution screen and the security execution screen in the non-security area. For example, the electronic device 101 may process the non-security execution area to occupy the display area corresponding to the non-security area and, accordingly, the security execution screen may not occupy the display area corresponding to the non-security area. That is, the security execution screen operates in the background mode.

In step 1511, the electronic device 101 replaces the security execution screen with a defined screen in accordance with the non-existence of the non-security execution screen and the security execution screen in the non-security area. For example, when only the security execution screen exists in the non-security area, the electronic device 101 may change the security execution screen located in the non-security area to a mosaic screen or change and display attribute information on the execution screen.

The electronic device 101 according to various embodiments of the present disclosure may return to the screen control process of FIG. 14 after arranging the non-security execution screen to display the non-security execution screen through the non-security area in step 1507 or replacing the security execution screen with the alternative screen in step 1511.

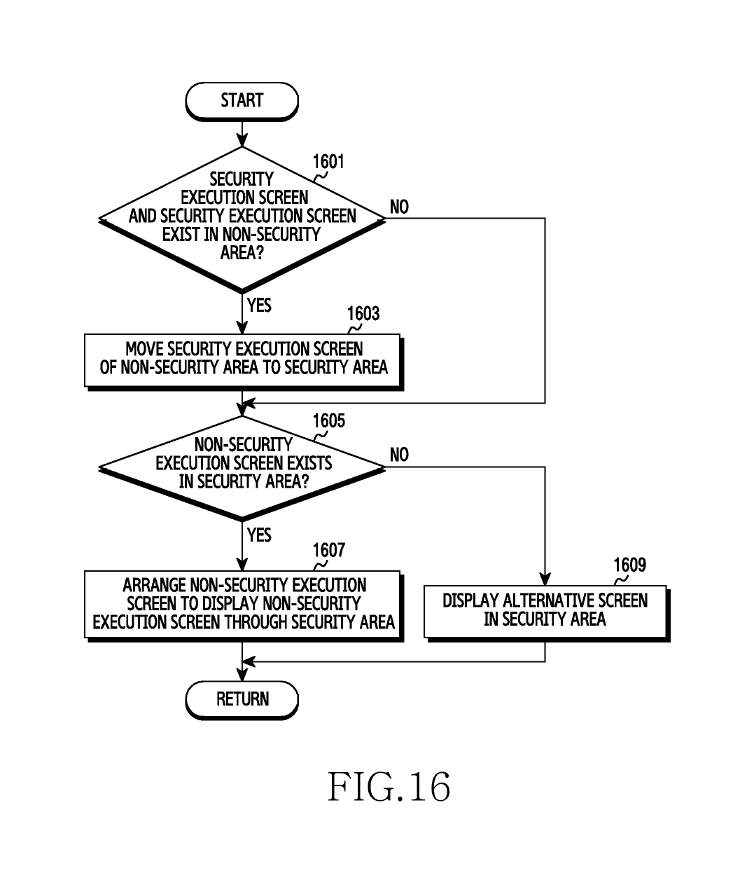

FIG. 16 is a flowchart illustrating another process of the electronic device 101 for stopping displaying the execution screen of the security application according to various embodiments of the present disclosure.

In step 1601, the electronic device 101 determines whether a security execution screen exists in a non-security area.

In step 1603, the electronic device 101 moves the security execution screen of the non-security area to the security area in accordance with the existence of the security execution screen in the non-security area. The security execution screen may be an execution screen operating in the background mode. Further, the security execution screen may be an execution screen operating in the foreground mode. That is, the electronic device 101 may move the security execution screen located in the non-security area to the security area regardless of the operation mode.

In step 1605, the electronic device 101 determines whether the non-security execution screen exists in the security area in accordance with the non-existence of the security execution screen in the non-security area or the movement of the security execution screen located in the non-security area to the security area.

In step 1607, the electronic device 101 processes the non-security execution screen to occupy the display area corresponding to the security area in accordance with the existence of the non-security execution screen in the security area. That is, the electronic device 101 may process the non-security execution screen to operate in the foreground mode.

In step 1609, the electronic device 101 displays a defined screen in the security area in accordance with the non-existence of the non-security execution screen in the security area.

The electronic device 101 according to various embodiments of the present disclosure may return to the screen control process of FIG. 14 after arranging the non-security execution screen to display the non-security execution screen through the security area in step 1607 or displaying the alternative screen in the security area in step 1609.

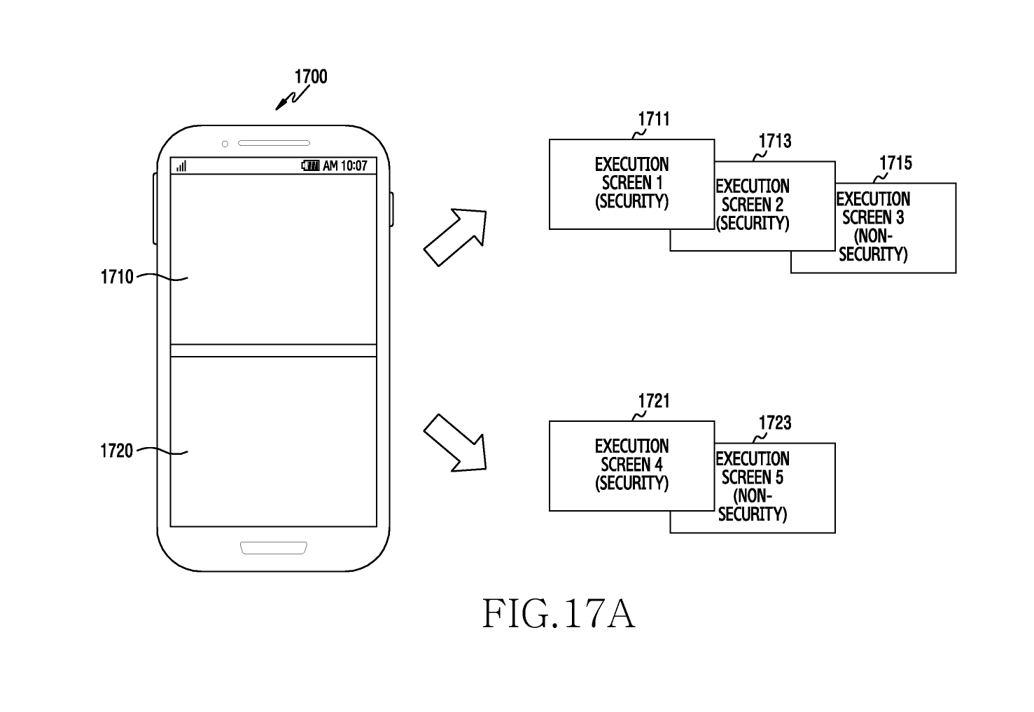

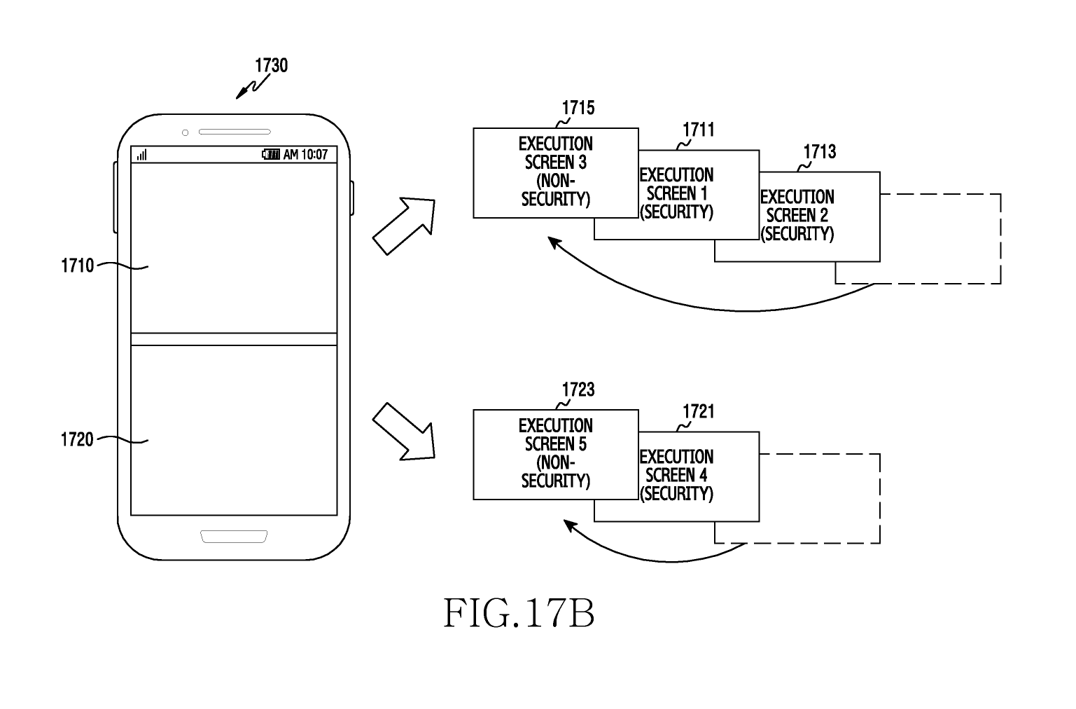

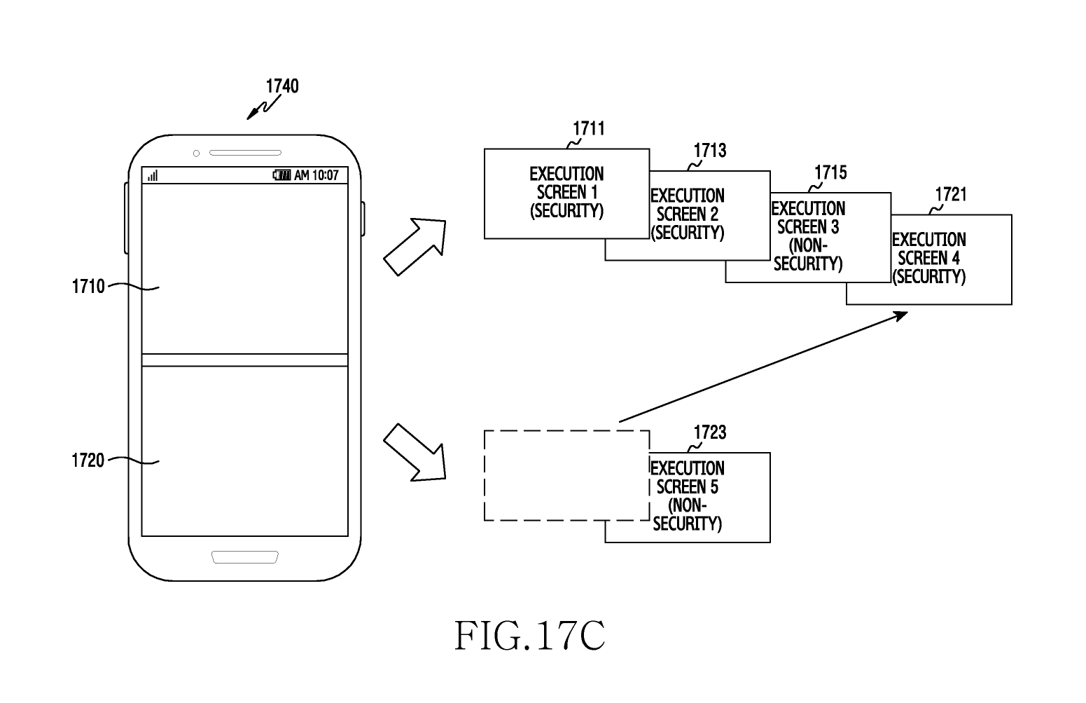

FIGS. 17A to 17C illustrate examples for describing a process in which the electronic device 101 stops displaying the execution screen of the security application according to various embodiments.

As illustrated in FIG. 17A, the electronic device 101 may define the display area as a security area 1710 and a non-security area 1720.

The electronic device 101 may display security execution screen 1 1711, security execution screen 2 1713, and non-security execution screen 3 1715 through the security area 1710. Security execution screen 1 1711 may operate in the foreground mode, and security execution screen 2 1713 and non-security execution screen 3 1715 may operate in the background mode. That is, only security execution screen 2 1711 may be displayed through the display area corresponding to the security area 1710.

Further, the electronic device 101 may display security execution screen 4 1721 and non-security execution screen 5 1723 through the non-security area 1720. Security execution screen 4 1721 may operate in the foreground mode, and non-security execution screen 5 1723 may operate in the background mode. That is, only security execution screen 4 1721 may be displayed through the display area corresponding to the non-security area 1720.

According to various embodiments of the present disclosure, the electronic device 101 may process non-security execution screen 3 1715, which operates in the background mode, to operate in the foreground mode as illustrated in FIG. 17B in accordance with activation of the security function. Accordingly, the electronic device 101 may process non-security execution screen 3 1711 to be displayed through the display area corresponding to the security area 1710 instead of security execution screen 1 1711 and the remaining execution screens to operate in the background mode.

Further, the electronic device 101 may process non-security execution screen 5 1723, which operates in the background mode, to operate in the foreground mode in order to stop displaying the security execution screen. Accordingly, the electronic device 101 may process non-security execution screen 5 1723 to be displayed in the display area corresponding to the non-security area 1720 instead of security execution screen 4 1721.

Further, the electronic device 101 may move security execution screen 4 1721, which is located in the non-security area 1720, to the security area 1710 as illustrated in FIG. 17C in order to stop displaying the security execution screen 4 1721 through the display area corresponding to the non-security area 1720.

In addition, the electronic device 101 may process only the security execution screen of the non-security area to operate in the security area in the background mode in order to stop displaying the security execution screen.

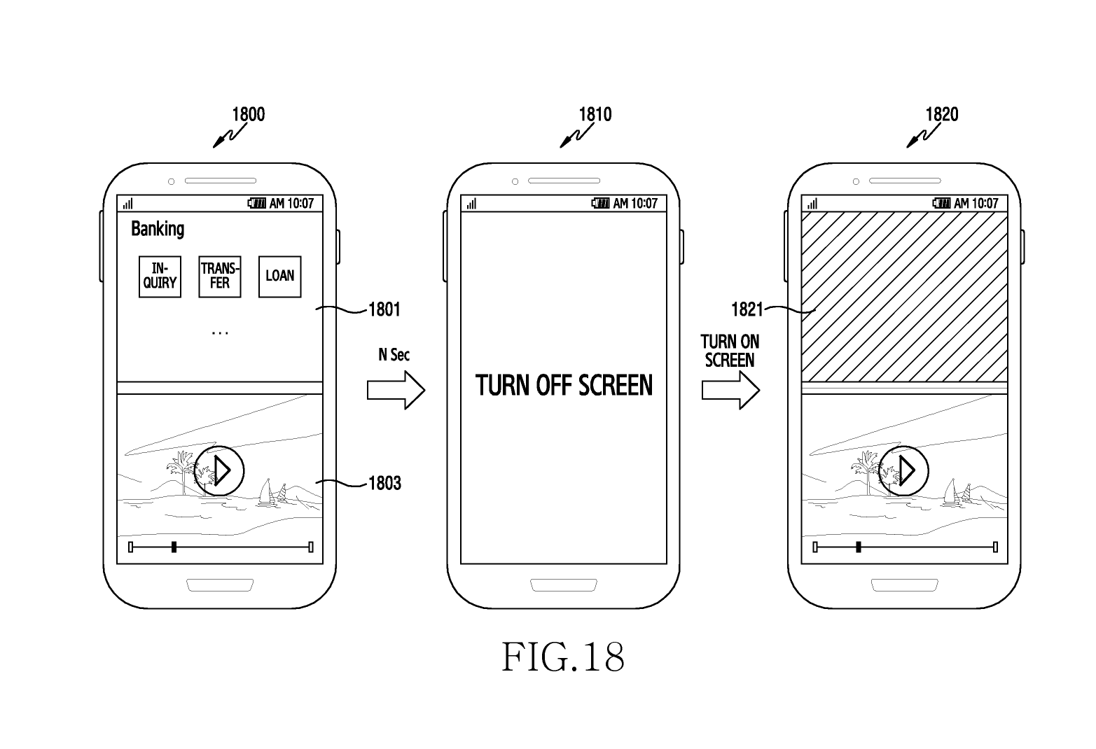

FIGS. 18 to 25 illustrate situations in which the electronic device stops displaying the security area and/or the execution screen of the security application according to various embodiments of the present disclosure.

According to various embodiments of the present disclosure, the electronic device 101 may display a security area 1801 and a non-security area 1803 on the screen in accordance with a user's input as indicated by reference numeral 1800 of FIG. 18. The security area 1801 may be a screen of the application in which the security is set according to a user's designation or a result of a designation in the electronic device 101. For example, in an application installation, a screen of a bank application set as the security application according to finance category information, may be displayed in the security area 1801 and an execution screen of a video player application in which the security is not set, may be displayed in the non-security area 1803. At least one application execution screen other than the execution screen of the bank application, which is currently displayed, may be displayed in the security area 1801 in the background. The security area 1801 may be designated by the user or by a security level of the application, which is being executed in the security area 1801. For example, the area 1801 may be designated as the security area while the bank application in which the security is set is displayed in the area 1801. Further, when a user's input is not detected for a predefined time or when a predefined input (for example, a hard key input or a soft key input) is detected, the electronic device 101 may process the screen to be turned off as indicated by reference numeral 1810. For example, when the hard key is input in a state where the screen is turned off, the electronic device 101 may process the screen to be turned on. At this time, the electronic device 101 may stop displaying the execution screen displayed in the security area 1801. For example, a predetermined screen 1821 may be displayed through the security area 1801 instead of the execution screen of the bank application as indicated by reference numeral 1820. The electronic device 101 may change at least some attributes of the execution screen displayed in the security area 1801. For example, a color and a brightness of the execution screen displayed in the security area 1801 may be controlled to be darker. When a user's input for identifying the predetermined screen 1821 is detected, the bank application may be displayed through the security area 1801 and a screen for authentication input may be displayed.

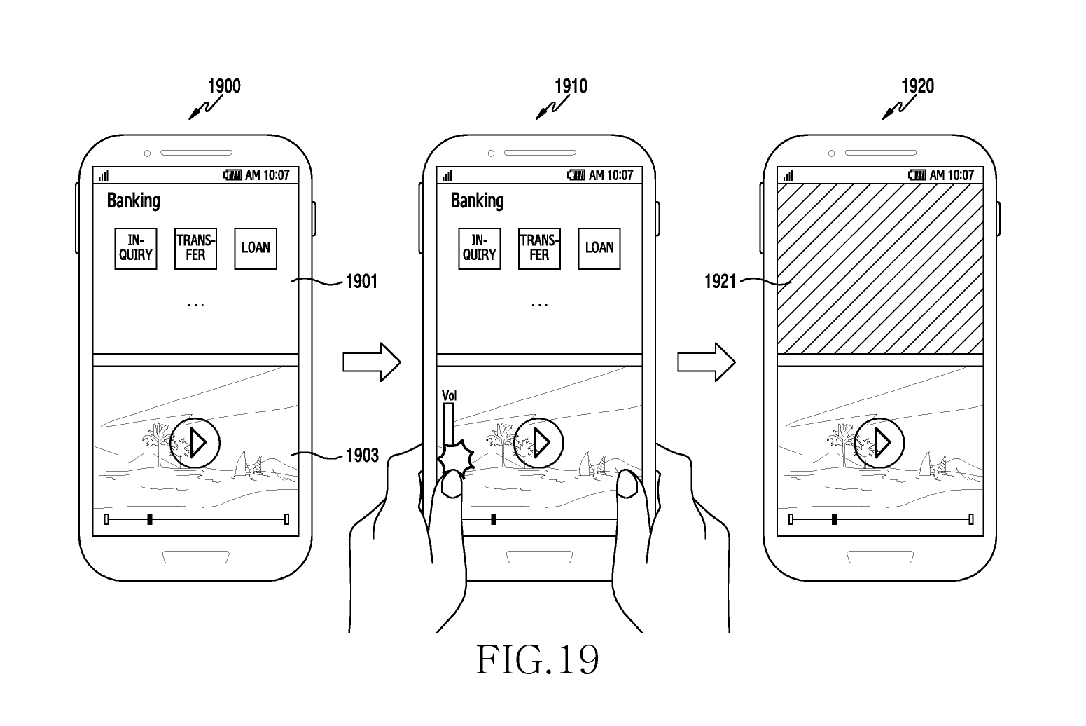

Referring to FIG. 19, the electronic device 101 may display different execution screens in a security area 1901 and a non-security area 1903 on the screen in accordance with a user's input as indicated by reference numeral 1900 of FIG. 19.

When an input in the security area 1901 is not detected for a predetermined time or when an input in the non-security area 1903 is detected as indicated by reference numeral 1910, the electronic device 101 may process a predetermined screen to be displayed through the security area 1901.

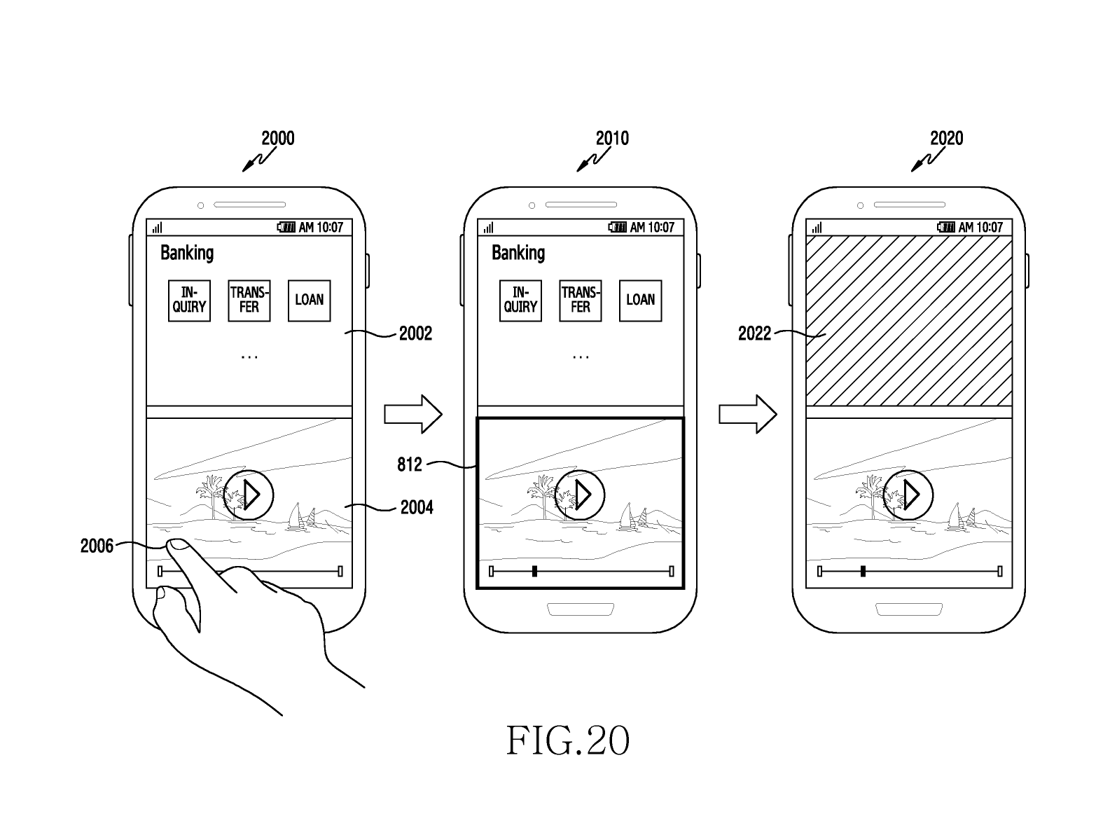

Referring to FIG. 20, the electronic device 101 may display a security area 2002 and a non-security area 2004 on the screen in accordance with a user's input as indicated by reference numeral 2000 of FIG. 20.

When an execution screen (for example, an execution screen in which the displaying is maintained) is designated through detection of an input 2006 as indicated by reference numeral 2010, the electronic device 101 may process the designated screen to be displayed through the security area 2002 as indicated by reference numeral 2020.

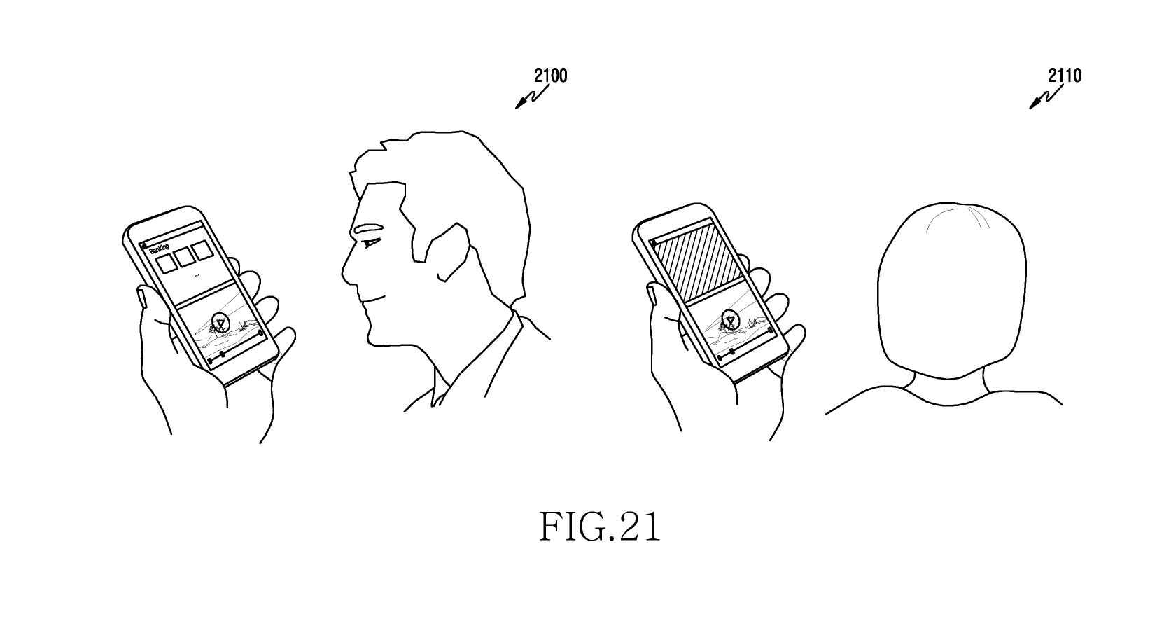

According to various embodiments of the present disclosure, the electronic device 101 may detect a user's face (for example, eyes) in a state where a security area and a non-security area are displayed on the screen according to a user's input as indicated by reference numeral 2100 of FIG. 21.

When it is determined that the user is not looking at the display, the electronic device 101 may process the designated screen to be displayed in the security area as indicated by reference numeral 2110.

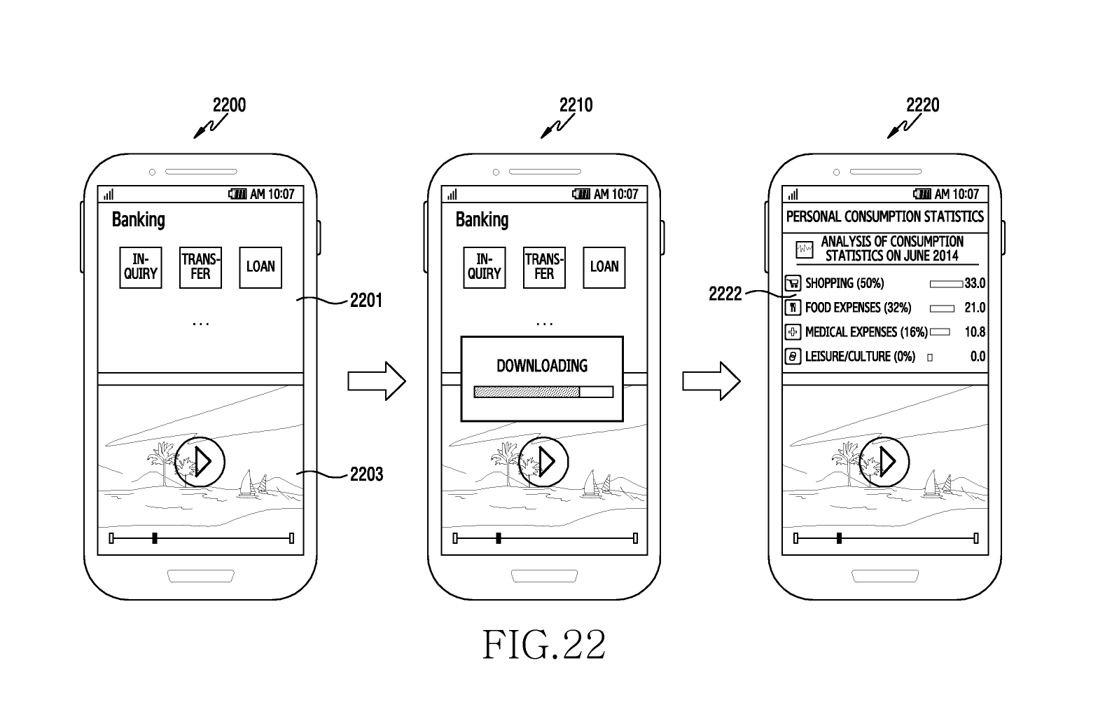

According to various embodiments of the present disclosure, the electronic device 101 may receive data in a state where a security area 2201 and a non-security area 2203 are displayed on the screen in accordance with a user's input as illustrated in FIG. 22. At this time, the data received by the electronic device 101 may be data associated with security or data transmitted by an external device associated with security.

In addition, when completion of the data reception is detected as indicated by reference numeral 2210, the electronic device 101 may display the received security data as indicated by reference numeral 2220. Accordingly, displaying of an execution screen of the received security data may stop according to a predetermined condition.

When a message is received from the user associated with the designated security application (when a screen for informing of the reception of the message appears), the electronic device 101 may display a message reception screen in the security area. When an application related to security is newly executed, the electronic device 101 may display an execution screen of the newly executed application in the security area.

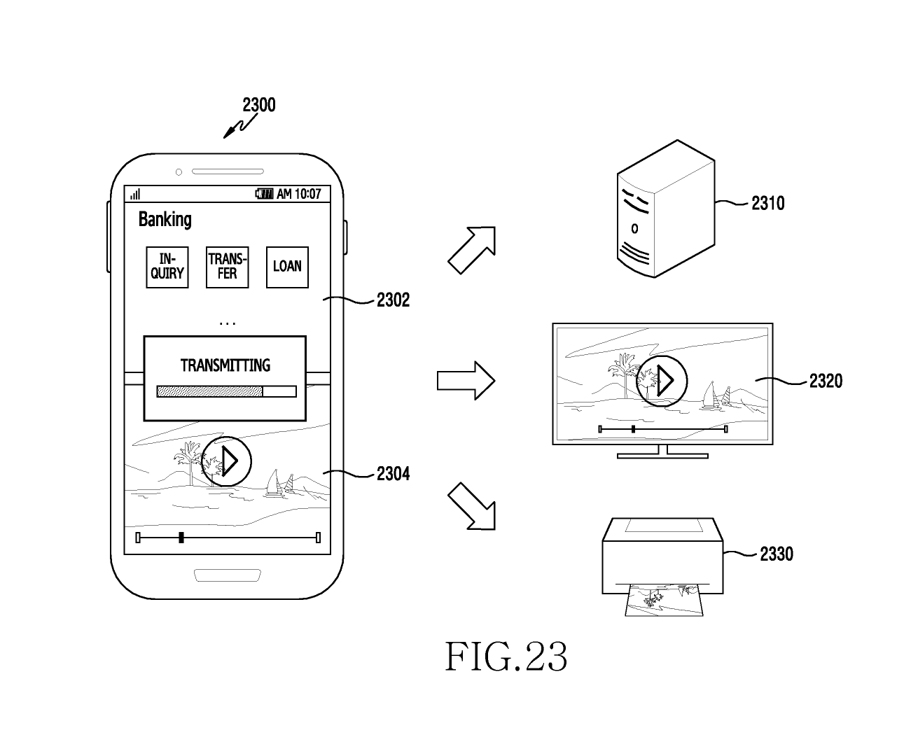

According to various embodiments of the present disclosure, the electronic device 101 may transmit data in a state where a security area 2302 and a non-security area 2304 are displayed on the screen in accordance with a user's input as illustrated in FIG. 23. At this time, the electronic device 101 may be connected to an external device such as a server 2310, a TV (or a monitor) 2320, a printer 2330, or a projector and transmit data thereto.

The electronic device 101 may prevent a security execution screen from being shared with the external device. For example, the electronic device 101 may transmit only data associated with the non-security area 2304 to the external device. The electronic device 101 may transmit information on an alternative screen, which is displayed instead of the security area 2302, to the external device.

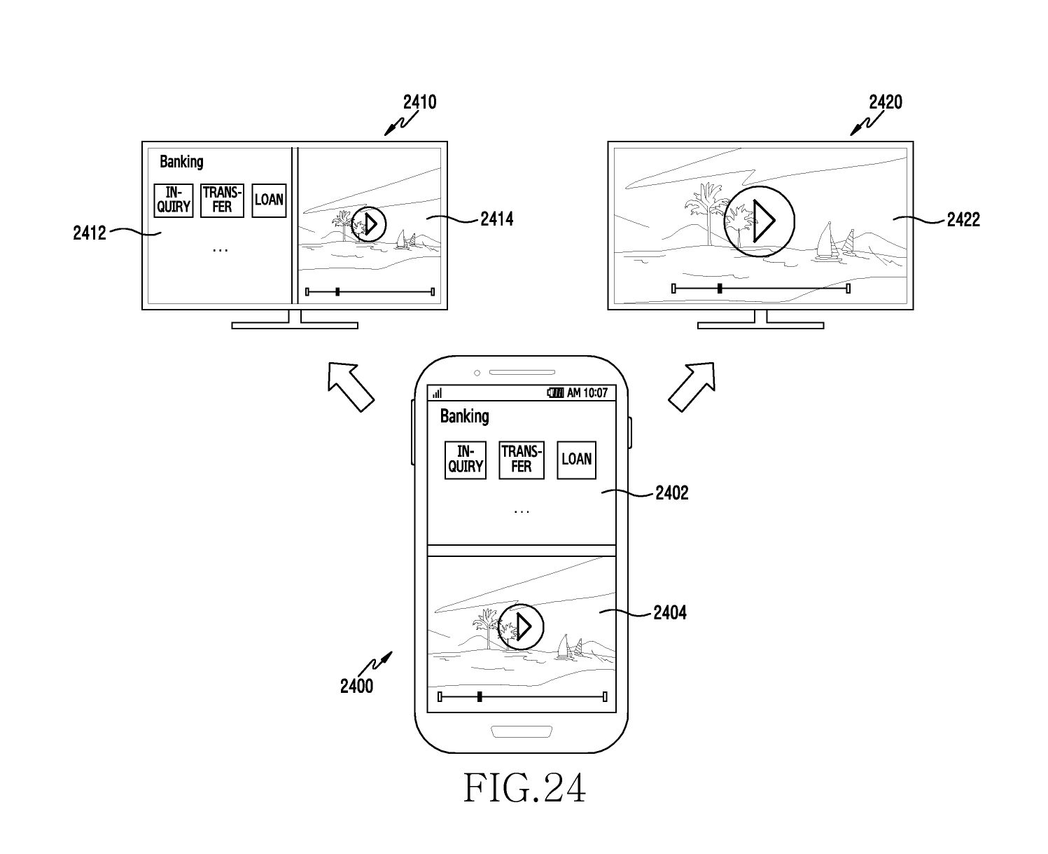

According to various embodiments of the present disclosure, the electronic device 101 may share a displayed execution screen in a state where a security area 2402 and a non-security area 2404 are displayed in accordance with a user's input as indicated by reference numeral 2400 of FIG. 24.

When the electronic device 101 is connected to an external device associated with security and shares the execution screen therewith, the electronic device 101 may share the screen displayed in the non-security area 2404 and/or the security area 2402 with the external device. Accordingly, the external device associated with security may display a screen 2414 corresponding to the non-security area and a screen 2412 corresponding to the security area as indicated by reference numeral 2410. The external device associated with security may display only the screen 2412 corresponding to the security area.

In addition, when the electronic device 101 is connected to an external device, which is not associated with security, and shares the execution screen therewith, the electronic device 101 may share only the screen corresponding to the non-security area 2404 with the external device. Accordingly, the external device, which is not associated with security, may display only a screen 2422 corresponding to the non-security area.

According to various embodiments of the present disclosure, the electronic device 101 may define an external device, which may be worn on the body, as the external device associated with security. The electronic device 101 may provide the screens displayed in the non-security area 2404 and the security area 2402 to the external device by communication with the external device, which may be worn on the body. In addition, the external device may display, for example, the screens corresponding to the non-security area 2404 and the security area 2402 provided from the electronic device 101. The external device may stop displaying at least some of the screens corresponding to the non-security area 2404 and the security area 2402 provided from the electronic device 101. For example, the external device may process only the screen corresponding to the non-security area 2404 to be displayed without displaying the screen corresponding to the security area 2402. In this case, the external device may display information indicating that the screen corresponding to the security area 240 is not displayed on at least some of the screen corresponding to the non-security area 2404.

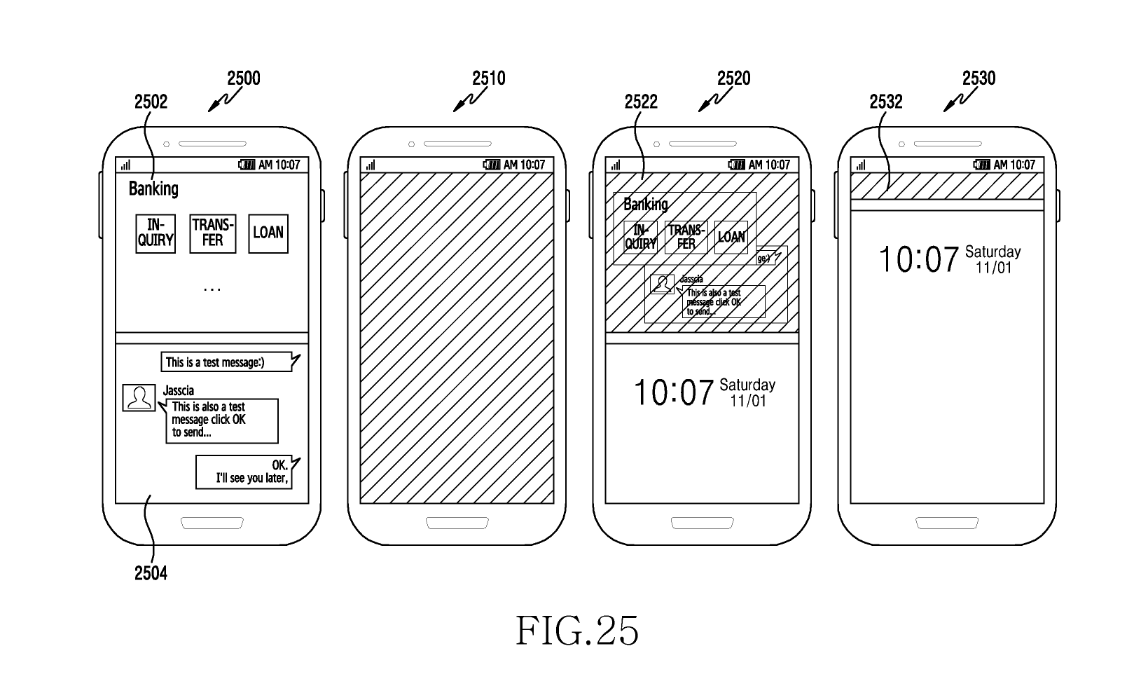

According to various embodiments of the present disclosure, the electronic device 101 may display a first security area 2502 and a second security area 2504 in accordance with a user's input as indicated by reference numeral 2500 of FIG. 25.

When a predetermined condition is met, the electronic device 101 may display a predetermined screen instead of the first security area 2502 and the second security area 2504 as indicated by reference numeral 2510. The electronic device 101 may move an execution screen corresponding to the second security area 2504 to the first security area 2502 according to a predetermined condition and then display a predetermined screen 2522 in a display area in which the execution screen is located as indicated by reference numeral 2520. At this time, the electronic device 101 may display a main screen in the second security area 2504. The electronic device 101 may control a size of a display area 2532 in which the predetermined screen is displayed according to a predetermined condition. For example, the electronic device 101 may reduce the display area 2532, in which the predetermined screen is displayed, to have a predetermined size of the second security area. Further, the electronic device 101 may move the display area 2532, reduced to have the predetermined size, to a predetermined location in an icon form (for example, to an edge of the display) and reconstruct the reduced display area according to a user's input.

A method of controlling a screen by an electronic device according to various embodiments of the present disclosure include an operation of displaying at least two execution screens, an operation of identifying an execution screen associated with security among execution screens displayed in accordance with activation of a security function, and an operation of stopping the displaying of at least some of the execution screen associated with security.

According to various embodiments, the security function may be activated based on conditions corresponding to at least one of a predetermined time, a connection with an external device, turning on of a screen after turning off the screen, data reception, a key input, and eye gaze direction.

According to various embodiments, the operation of stopping displaying the execution screen associated with security may include an operation of processing the execution screen associated with security to not occupy a display area.

According to various embodiments, the operation of stopping the displaying of the execution screen associated with security may include an operation of replacing the execution screen associated with security with a predetermined screen.

According to various embodiments, the predetermined screen may include at least one of a lock screen, a mosaic screen, an execution screen having changed attribute information, and a screen designated by a user.

According to various embodiments, the operation of stopping the displaying of the execution screen associated with security may include an operation of moving the execution screen associated with security to a predetermined security area.

According to various embodiments, the operation of stopping the displaying of the execution screen associated with security may include an operation of switching the execution screen associated with security to a background mode.

According to various embodiments, the operation of stopping the displaying of the execution screen associated with security may include an operation of stopping transmission of the execution screen associated with security to an external device.

According to various embodiments, the operation of stopping the displaying of the execution screen associated with security may include an operation of displaying received data through a display area corresponding to a defined security received from an external device.

According to various embodiments, the execution screen associated with security may be related to an application selected based on at least one of a user's input, attributes of an application, and a use pattern of an application.

A computer-readable recording medium according to various embodiments of the present disclosure may record a program to execute an operation of displaying at least two execution screens, an operation of identifying an execution screen associated with security among execution screens displayed in accordance with activation of a security function, and an operation of stopping the displaying of at least some of the execution screen associated with security.

A method of controlling a screen and an electronic device for processing the method according to various embodiments of the present disclosure may improve security of, for example, at least an execution screen associated with security among a plurality of execution screens output to a display.

The present disclosure and accompanying drawings merely suggest certain examples to describe the technical content of the present disclosure and help in the understanding of the present disclosure, and do not limit the scope and spirit of the present disclosure. Accordingly, it should be understood that the scope of the present disclosure includes all modifications or changes drawn on the basis of the technical scope and spirit of the present disclosure, besides the embodiments disclosed herein, as defined by the appended claims and their equivalents.

What is claimed is:

1. An electronic device for controlling a screen, the electronic device comprising:
a display unit that displays at least two execution screens; and
a controller that identifies an execution screen associated with security among execution screens displayed in accordance with activation of a security function, and stops displaying of at least some of the execution screen associated with security.

2. The electronic device of claim 1, wherein the security function is activated based on conditions corresponding to at least one of a predetermined time, a connection with an external device, turning on a screen after turning off the screen, data reception, a key input, and eye gaze direction.

3. The electronic device of claim 1, wherein the controller processes the execution screen associated with security to not occupy a display area.

4. The electronic device of claim 1, wherein the controller replaces the execution screen associated with security with a predetermined screen.

5. The electronic device of claim 4, wherein the predetermined screen includes at least one of a lock screen, a mosaic screen, an execution screen having changed attribute information, and a screen designated by a user.

6. The electronic device of claim 1, wherein the controller defines at least some of the display unit as a security area and moves the execution screen associated with security to the defined security area.

7. The electronic device of claim 1, wherein the controller switches the execution screen associated with security to a background mode.

8. The electronic device of claim 1, wherein the controller stops transmission of the execution screen associated with security in accordance with a connection with an external device.

9. The electronic device of claim 1, wherein the controller displays received data through a display area corresponding to a defined security area received from an external device.

10. The electronic device of claim 1, wherein the execution screen associated with security is related to an application selected based on at least one of a user's input, attributes of an application, and a use pattern of an application.

11. A method of controlling a screen by an electronic device, the method comprising:
displaying at least two execution screens;
identifying an execution screen associated with security among execution screens displayed in accordance with activation of a security function; and
stopping displaying of at least some of the execution screen associated with security.

12. The method of claim 11, wherein the security function is activated based on conditions corresponding to at least one of a predetermined time, a connection with an external device, turning on a screen after turning off the screen, data reception, a key input, and eye gaze direction.

13. The method of claim 11, wherein stopping displaying of the execution screen associated with security comprises processing the execution screen associated with security to not occupy a display area.

14. The method of claim 11, wherein stopping displaying of the execution screen associated with security comprises replacing the execution screen associated with security with a predetermined screen.

15. The method of claim 14, wherein the predetermined screen includes at least one of a lock screen, a mosaic screen, an execution screen having changed attribute information, and a screen designated by a user.

16. The method of claim 11, wherein stopping displaying of the execution screen associated with security comprises moving the execution screen associated with security to a predetermined security area.

17. The method of claim 11, wherein stopping displaying of the execution screen associated with security comprises switching the execution screen associated with security to a background mode.

18. The method of claim 11, wherein stopping displaying of the execution screen associated with security comprises stopping transmission of the execution screen associated with security in accordance with a connection with an external device.

19. The method of claim 11, wherein stopping displaying of the execution screen associated with security comprises displaying received data through a display area corresponding to a defined security area received from an external device.

20. The method of claim 11, wherein the execution screen associated with security is related to an application selected based on at least one of a user's input, attributes of an application, and a use pattern of an application.
